(19) United States
(12) Patent Application Publication
(10) Pub. No.: US 2010/0092082 A1
(43) Pub. Date: Apr. 15, 2010

(54) FRAMEWORK FOR WAVELET-BASED ANALYSIS AND PROCESSING OF COLOR FILTER ARRAY IMAGES WITH APPLICATIONS TO DENOISING AND DEMOSAICING

(76) Inventors: Keigo Hirakawa, Cambridge, MA (US); Xiao-Li Meng, Brookline, MA (US); Patrick J. Wolfe, Cambridge, MA (US)

Correspondence Address: LANDO & ANASTASI, LLP, ONE MAIN STREET, SUITE 1100, CAMBRIDGE, MA, 02142, US

(21) Appl. No.: 12/516,725

(22) PCT Filed: Nov. 29, 2007
(86) PCT No.: PCT/US07/85955

§ 371 Date: Dec. 7, 2009

Related U.S. Application Data
(60) Provisional application No. 60/861,669, filed on Nov. 29, 2006.

(51) Int. Cl. G06K 9/40

(52) U.S. Cl. 382/167; 382/275

(57) ABSTRACT

One aspect of the present invention relates to a new approach to the demosaicing of spatially sampled image data observed through a color filter array. In one embodiment properties of Smith-Barnwell filterbanks may be employed to exploit the correlation of color components in order to reconstruct a sub-sampled image. In other embodiments, the approach is amenable to wavelet-domain denoising prior to demosaicing. One aspect of the present invention relates to a framework for applying existing image denoising algorithms to color filter array data. In addition to yielding new algorithms for denoising and demosaicing, in some embodiments, this framework enables the application of other wavelet-based denoising algorithms directly to the CFA image data. Demosaicing and denoising according to some embodiments of the present invention may perform on a par with the state of the art for far lower computational cost, and provide a versatile, effective, and low-complexity solution to the problem of interpolating color filter array data observed in noise. According to one aspect, a method for processing an image is provided. In one embodiment, image data captured though a color filter array is trans-formed into a series of filterbank subband coefficients, by estimating the filterbank transform for a complete image (which estimation can be shown to be accurate in some embodiments) computation complexity associated with regenerating the complete image can be reduced. In another embodiment, denoising of the CFA image data can occur prior to demosaicing, alternatively denoising can occur in conjunction with demosaicing, or in another alternative, after demosaicing.

### BACKGROUND

1. Field of Invention

The present invention relates to image acquisition, and more particularly to wavelet-based processing of a sub-sampled image.

2. Discussion of Related Art

In digital imaging applications, data are typically obtained via a spatial subsampling procedure implemented as a color filter array (CFA), a physical construction whereby each pixel location measures only a single color. The most well known of these schemes involve the three colors of light: red, green, and blue. In particular, the Bayer pattern CFA, shown in FIG. 1, attempts to complement humans' spatial color sensitivity via a quincunx sampling of the green component that is twice as dense as that of red and blue.

The terms “demosaicing” and “demosaicking” refers to the inverse problem of reconstructing a spatially undersampled vector field whose components correspond to these primary colors. It is well known that the optimal solution to this ill-posed inverse problem, in the L² sense of an orthogonal projection onto the space of bandlimited functions separately for each spatially subsampled color channel, produces unacceptable visual distortions and artifacts.

Aside from the spatial undersampling inherent in the Bayer pattern, this phenomenon can be attributed to the observation that values of the color triple exhibit significant correlation, particularly at high spatial frequencies: such content often signifies the presence of edges, whereas low-frequency information contributes to distinctly perceived color content. As such, most demosaicing algorithms described in the literature attempt to make use (either implicitly or explicitly) of this correlation structure in the spatial frequency domain.

### SUMMARY

One aspect of the present invention relates to a new approach to demosaicing of spatially sampled image data observed through a color filter array, in which properties of Smith-Barnwell filterbanks may be employed to exploit the correlation of color components in order to reconstruct a subsampled image. In some embodiments, the approach is amenable to wavelet-domain denoising prior to demosaicing. One aspect of the present invention relates to a framework for applying existing image denoising algorithms to color filter array data. In addition to yielding new algorithms for denoising and demosaicing, in some embodiments, this framework enables the application of other wavelet-based denoising algorithms directly to the CFA image data. Demosaicing and denoising according to some embodiments of the present invention may perform on a par with the state of the art for far lower computational cost, and provide a versatile, effective, and low-complexity solution to the problem of interpolating color filter array data observed in noise.

According to one aspect of the present invention, a method of generating a processed representation of at least one image from a sub-sampled representation of the at least one image is provided. The method comprises A) determining a plurality of filterbank subband coefficients based, at least in part, on the sub-sampled representation, and B) generating at least a portion of the processed representation by approximating at least one filterbank subband coefficient of the processed representation based, at least in part, on at least one of the plurality of filterbank subband coefficients, wherein the plurality of filterbank subband coefficients are adapted to conform to Smith-Barwell properties. According to one embodiment of the present invention, the method further comprises an act of C) denoising the at least one of the plurality of filterbank subband coefficients before approximating the at least one filterbank subband coefficient of the processed representation. According to another embodiment of the invention, the at least one of the plurality of filterbank subband coefficients includes at least one wavelet coefficient. According to another embodiment of the invention, the wavelet coefficient describes a Daubechies wavelet. According to another embodiment of the invention, the wavelet coefficient describes a Haar wavelet. According to another embodiment of the invention, wherein B) comprises combining spectrum information from at least a subset of the plurality of filterbank subband coefficients to approximate the at least one filterbank subband coefficient of the processed representation. According to another embodiment of the invention, the at least one image includes a plurality of images that comprise a video.

According to one aspect of the present invention, an image processing apparatus is provided comprising a processor configured to determine a plurality of filterbank subband coefficients based, at least in part, on a sub-sampled representation of at least one image, and configured to generate at least a portion of a processed representation of the at least one image by approximating at least one filterbank subband coefficient of the processed representation based, at least in part, on at least one of the plurality of filterbank subband coefficients. According to one embodiment of the invention, the processor is further configured to denoise the at least one of the plurality of filterbank subband coefficients before approximating the at least one filterbank subband coefficient of the processed representation. According to another embodiment of the invention, the at least one of the plurality of filterbank subband coefficients includes at least one wavelet coefficient. According to another embodiment of the invention, the wavelet coefficient describes a Daubechies wavelet. According to another embodiment of the invention, the wavelet coefficient describes a Haar wavelet. According to another embodiment of the invention, the processor is configured to combine spectrum information from at least a subset of the plurality of filterbank coefficients to approximate the at least one filterbank subband coefficient of the processed representation. According to another embodiment of the invention, the at least one image includes a plurality of images that comprise a video.

According to one aspect of the present invention, a method for processing an image is provided. The method comprises acts of capturing image data through a color filter array, transforming the image data using at least one filterbank, reconstructing an image from the processed image data. According to another embodiment of the invention, reconstructing an image from the processed image data further comprises an act of approximating at least one filterbank subband coefficient. According to another embodiment of the invention, transforming the image data using at least one filterbank further comprises separating color components of the spatially sampled image data. According to another embodiment of the invention, transforming the image data using at least one filterbank further comprises separating spectral energy of individual color components. According to another embodiment of the invention, separating spectral energy of individual color components includes an act of using a wavelet transform. According to another embodiment of the invention, separating the spectral energy of individual color components further comprises an act of using a two-level wavelet transform.

According to one embodiment of the present invention, separating the spectral energy of individual color components further comprises an act of using a multi-level wavelet transform. According to another embodiment of the invention, transforming the image data using at least one filterbank further comprises decomposing the image data into a plurality of filterbank subband coefficients. According to another embodiment of the invention, the plurality of filterbank subband coefficients comprise a complete filterbank. According to another embodiment of the invention, the plurality of filterbank subband coefficients comprise an overcomplete filterbank. According to another embodiment of the invention, the plurality of filterbank subband coefficients comprise at least one of complete filterbank, an overcomplete filterbank, an undecimated wavelet coefficient, and a decimated wavelet coefficient According to another embodiment of the invention, at least one of the plurality of filterbank subband coefficients comprises at least one wavelet coefficient. According to another embodiment of the invention, the at least one wavelet coefficient describes a Daubechies wavelet. According to another embodiment of the invention, the at least one wavelet coefficient describes a Harr wavelet. According to another embodiment of the invention, the method further comprises an act of denoising the image data prior to demosaicing the image data.

According to one embodiment of the present invention, the act of transforming the image data using at least one filterbank further comprises an act of performing denoising on the image data. According to another embodiment of the invention, the act of performing denoising on the image is wavelet based. According to another embodiment of the invention, the method further comprises an act of estimating a luminance component of an image. According to another embodiment of the invention, the image data comprises a plurality of images. According to another embodiment of the invention, the plurality of images comprise video.

According to one aspect of the present invention, a method for reducing computational complexity associated with recovering an image is provided. The method comprises accessing image data captured through a color filter array, transforming the image data into a plurality of subband coefficients using a filterbank, estimating at least one subband coefficient for a complete image based, at least in part, on the plurality of subband coefficients, reconstructing, at least part of a complete image, using the estimated at least one subband coefficient for the complete image. According to one embodiment of the present invention, the method further comprises an act of denoising the image data. According to another embodiment of the invention, the act of denoising the image data occurs prior to demosaicing the image data. According to another embodiment of the invention, the act of transforming the image data using at least one filterbank further comprises an act of performing denoising on the image data. According to another embodiment of the invention, the act of performing denoising on the image is wavelet based. According to another embodiment of the invention, the method further comprises an act of estimating a luminance component of an image.

According to one aspect of the present invention, an image processing apparatus is provided. The apparatus comprises a processor adapted to transform image data into a plurality of subband coefficients using a filterbank, estimate at least one subband coefficient for a complete image, based, at least in part, on the plurality of coefficients, and reconstruct, at least part of a complete image, using the estimated at least one subband coefficient for the complete image. According to one embodiment of the present invention, the processor is further adapted to denoise the image data. According to another embodiment of the invention, the processor is further adapted to denoise the image data prior to demosaicing the image data. According to another embodiment of the invention, the processor is further adapted to transform the image data using at least one filterbank and denoise the image data as part of the same process. According to another embodiment of the invention, the processor is adapted to use wavelet based denoising. According to another embodiment of the invention, the processor is further adapted to estimate a luminance component of an image.

According to one aspect of the present invention, a computer-readable medium having computer-readable signals stored thereon that define instructions that, as a result of being executed by a computer, instruct the computer to perform a method for generating a processed representation of at least one image from a sub-sampled representation of the at least one image is provided. The method comprises acts of determining a plurality of filterbank subband coefficients based, at least in part, on the sub-sampled representation, and generating at least a portion of the processed representation by approximating at least one filterbank subband coefficient of the processed representation based, at least in part, on at least one of the plurality of filterbank subband coefficients. According to one embodiment of the present invention, the method further comprises denoising the at least one of the plurality of filterbank subband coefficients before approximating the at least one filterbank subband coefficient of the processed representation. According to another embodiment of the invention, the at least one of the plurality of filterbank subband coefficients includes at least one wavelet coefficient. According to another embodiment of the invention, generating at least a portion of the processed representation by approximating at least one filterbank subband coefficient of the processed representation based, at least in part, on at least one of the plurality of filterbank subband coefficients further comprises combining spectrum information from at least a subset of the plurality of filterbank subband coefficients to approximate the at least one filterbank subband coefficient of the processed representation. According to another embodiment of the invention, the at least one image includes a plurality of images that comprise a video.

According to one aspect of the present invention, a computer-readable medium having computer-readable signals stored thereon that define instructions that, as a result of being executed by a computer, instruct the computer to perform a method for processing an image is provided. The method comprises accessing image data captured through a color filter array, transforming the image data using at least one filterbank, reconstructing an image from the processed image data. According to one embodiment of the present invention, reconstructing an image from the processed image data further comprises an act of approximating at least one filterbank subband coefficient. According to another embodiment of the invention, transforming the image data using at least one filterbank further comprises separating color components of the spatially sampled image data. According to another embodiment of the invention, transforming the image data using at least one filterbank further comprises separating spectral energy of individual color components. According to another embodiment of the invention, separating spectral energy of individual color components includes an act of using a wavelet transform. According to another embodiment of the invention, separating the spectral energy of individual color components further comprises an act of using a two-level wavelet transform. According to another embodiment of the invention, separating the spectral energy of individual color components further comprises an act of using a multi-level wavelet transform.

According to one embodiment of the present invention, transforming the image data using at least one filterbank further comprises transforming the image data into a plurality of filterbank subband coefficients. According to another embodiment of the invention, the plurality of filterbank subband coefficients comprise a complete filterbank. According to another embodiment of the invention, the plurality of filterbank subband coefficients comprise an overcomplete filterbank. According to another embodiment of the invention, the plurality of filterbank subband coefficients comprise at least one of complete filterbank, an overcomplete filterbank, an undecimated wavelet coefficient, and a decimated wavelet coefficient According to another embodiment of the invention, at least one of the plurality of filterbank subband coefficients comprises at least one wavelet coefficient. According to another embodiment of the invention, the at least one wavelet coefficient describes a Daubechies wavelet. According to another embodiment of the invention, the at least one wavelet coefficient describes a Harr wavelet. According to another embodiment of the invention, the method further comprises an act of denoising the image data prior to demosaicing.

According to one embodiment of the present invention, the act of transforming the image data using at least one filterbank further comprises an act of performing denoising on the image data. According to another embodiment of the invention, the act of performing denoising on the image is wavelet based. According to another embodiment of the invention, the method further comprises an act of estimating a luminance component of an image.

According to one aspect of the present invention, a computer-readable medium having computer-readable signals stored thereon that define instructions that, as a result of being executed by a computer, instruct the computer to perform a method for reducing computational complexity associated with recovering an image if provided. The method comprises accessing image data captured through a color filter array, transforming the image data into a plurality of subband coefficients using a filterbank, estimating at least one subband coefficient for a complete image based, at least in part, on the plurality of subband coefficients, and reconstructing, at least part of a complete image, using the estimated at least one subband coefficient for the complete image.

### BRIEF DESCRIPTION OF DRAWING

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a Bayer pattern CFA;

FIG. 2 illustrates an example image capturing device according to one embodiment of the present invention;

FIGS. 3A-P illustrate frequency-domain representations of CFA data;

FIGS. 4A-B, illustrate two representations of equivalent filterbanks;

FIGS. 5A-B, illustrate two tables indicating results of performing various methods on CFA data;

FIGS. 6A-I, illustrate representations of the ‘clown” image and the same image with various method applied;

FIG. 7 illustrates an example process that may be used to process image data;

FIG. 8(a)-(f) illustrate color images captured using different color filter arrays and with processing;

FIG. 9(a)-(d) illustrate examples of log-magnitude spectra of a color image;

FIGS. 10(a)-(b) illustrate examples of aliasing structure in local spectra and conditioned local image features of the surrounding;

FIG. 11 illustrates an example of a one level filterbank;

FIGS. 12(a)-(b) illustrate examples of two equivalent filterbanks; and

FIGS. 13(a)-(b) illustrate examples of two equivalent filterbanks.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

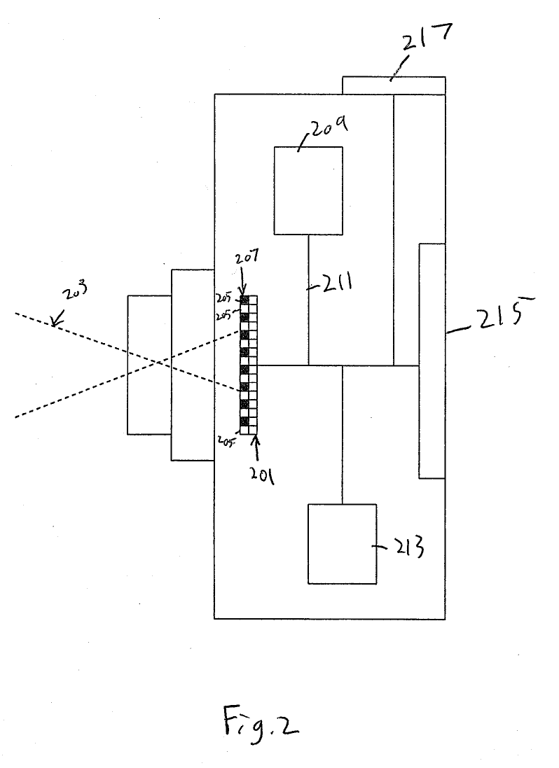

Various embodiments of the present invention may include one or more cameras or other image capturing devices. In some embodiments, a camera 200, as illustrated in FIG. 2, may include a plurality of light sensitive elements 201. Each light sensitive element may be configured to measure a magnitude of light 203 at a location within an image being captured. The measurements of light may later be combined to create a representation of the image being captured in a process referred to as demosaicing.

In one embodiment of the present invention, the plurality of light sensitive elements 201 may include a plurality of photo sensitive capacitors of a charge-coupled device (CCD). In one embodiment, the plurality of light sensitive elements 201 may include one or more complementary metal-oxide-semiconductor (CMOS). During image capture, each photo sensitive capacitor may be exposed to light 203 for a desired period of time, thereby generating an electric charge proportional to a magnitude of the light at a corresponding image location. After the desired period of time, the electric charges of each of the photosensitive capacitors may then be measured to determine the corresponding magnitudes of light at each image location.

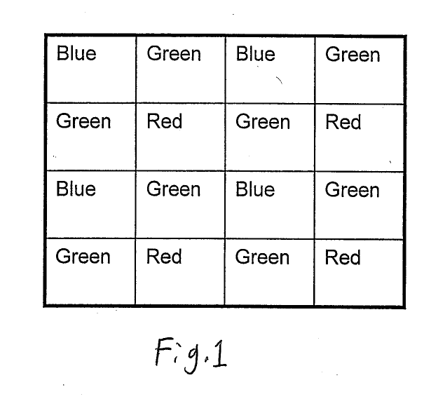

In some embodiments of the present invention, in order to capture a color image, one or more color filters 205 may be disposed on one or more of the light sensitive elements 201. A color filter 205 may allow only a desired portion of light of one or more desired colors (i.e., wavelengths) to pass from an image being captured to the respective light sensitive element on which the color filter 205 is disposed. In some implementations, a color filter may be generated by placing a layer of coloring materials (e.g., ink, dye) of a desired color or colors on at least a portion of a clear substrate. In traditional image capturing applications, the color filters are arranged into a color filter array 207 having colors arranged in a pattern known as the Bayer pattern, which is shown in FIG. 1 and described in more detail below.

In some embodiments, an indication of the magnitudes of light measured by each light sensitive element may be transmitted to at least one processor 209. In one embodiment in which a plurality of photosensitive capacitors of a CCD are used as light sensitive elements 201, the current in each photo sensitive capacitor may be measured and converted into a signal that is transmitted from the CCD to the processors. In some embodiments, the processor 209 may include a general purpose microprocessor and/or an application specific integrated circuit (ASIC). In some embodiments, the processor may include memory elements (e.g., registers, RAM, ROM) configured to store data (e.g., measured magnitudes of light, processing instructions, demosaiced representations of the original image). In some embodiments, the processor 209 may be part of the image capturing device (e.g., camera 200). In other embodiments, the processor 209 may be part of a general purpose computer or other computing device.

In some embodiments, the processor 209 may be coupled to a communication network 211 (e.g., a bus, the Internet, a LAN). In some embodiments, one or more storage components 213, a display component 215, a network interface component (not shown), a user interface component 217, and/or any other desired component may be coupled to the communication network 211 and communicate with the processor 209. In some implementations, the storage components 213 may include nonvolatile storage components (e.g., memory cards, hard drives, ROM) and/or volatile memory (e.g., RAM). In some implementations, the storage components 213 may be used to store mosaiced and/or demosaiced representations of images captured using the photo sensitive elements 201.

In some embodiments, the processor 209 may be configured to perform a plurality of processing functions, such as responding to user input, processing image data from the photosensitive elements 201, and/or controlling the storage and display components 213, 215. In some embodiments, one or more such processors may be configured to perform demosaicing and/or denoising functions on image data captured by the light sensitive elements 201 in accordance with the present invention.

In some embodiments, the image capturing device (e.g., camera 200) and/or processor 209 may be configured to store or transmit at least one representation of an image (e.g., on an internal, portable, and/or external storage device, to a communication network). In some implementations, the representation may include a representation of the image that has been demosaiced and/or denoised in accordance with an embodiment of the present invention. In some implementations the representation may include a representation of the magnitudes of light measured by the light sensitive elements 201. In some embodiments, the representation may be stored or transmitted in a machine readable format, such as a JPEG or any other electronic file format.

In some embodiments, the image capturing device may include a video camera configured to capture representations of a series of images. In addition to or as an alternative to capturing a representation of a single image, as described above, such a video camera may capture a plurality of representations of a plurality of images over time. The plurality of representations may comprise a video. The video may be stored on a machine readable medium in any format, such as a MPEG or any other electronic file format.

### Spectral Analysis of CFA Images

One aspect of the present invention relates to performing wavelet analysis of sub-sampled CFA images according to fundamental principles of Fourier analysis and filterbanks to generate an approximation of an original image. In one embodiment, the present invention provides a new framework for wavelet-based CFA image denoising and demosaicing methods, which in turn enables the application of existing wavelet-based image denoising techniques directly to sparsely sampled data. This capability is important owing to the fact that various noise sources inherent to the charge-coupled device (CCD) or other imaging technique employed must be taken into account in practice. In some implementations, noise reduction procedures take place prior to demosaicing (both to improve interpolation results and to avoid introducing additional correlation structure into the noise). While earlier work has been focused primarily on demosaicing prior to denoising, embodiments of the present invention perform wavelet-based denoising and demosaicing together in the same process.

In one aspect of the present invention, it is recognized that the CFA image may be viewed as the sum of a fully observed green pixel array and sparsely sampled difference images corresponding to red and blue. Specifically, let n=(n₀,n₁) index pixel locations and define

x(n)=(r(n),g(n),b(n)) (1)

to be the corresponding color triple at a pixel location. If we define difference signals α(n)=r(n)−g(n) and β(n)=b(n)−g(n), then the CFA image is given by

$$\begin{matrix}y ( n ) = g ( n ) + {α}_{s} ( n ) + {β}_{s} ( n ) , \\ where & ( 2 ) \\ {α}_{s} ( n ) := \{ \begin{matrix}r ( n ) - g ( n ) & if {n}_{0} , {n}_{1} even \\ 0 & otherwise\end{matrix} \\ {β}_{s} ( n ) := \{ \begin{matrix}b ( n ) - g ( n ) & if {n}_{0} , {n}_{1} odd \\ 0 & otherwise\end{matrix} & ( 3 )\end{matrix}$$

are the sparsely sampled difference images.

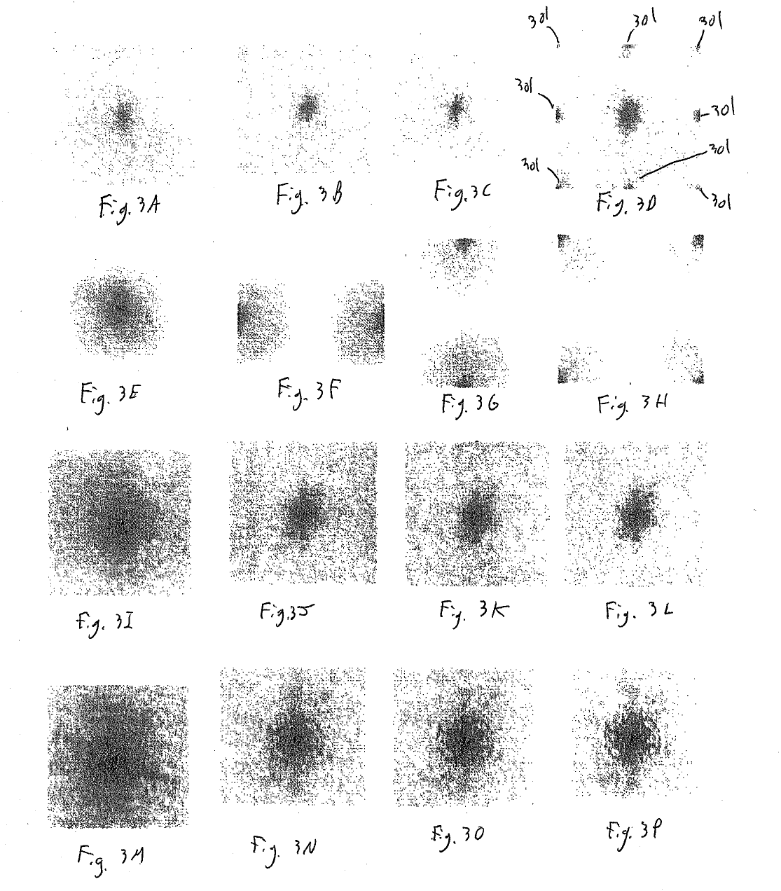

The fact that difference channels α(n) and β(n) may exhibit rapid spectral decay relative to the green channel g(n) follows from the (de-)correlation of color content at high frequencies, as described above. This result is well known, and may be observed empirically in FIGS. 3A-C, which show the log-magnitude spectra of g(n), α(n), β(n), respectively denoted by G(ω), A(ω), B(ω) for frequency variable w=[w₀ w₁]^{T} of a well-known sample image known as “clown” obtained using a Bayer pattern CFA.

It follows from the composition of the dyadic decimation and interpolation operators induced by the Bayer sampling pattern that the Fourier transform Y(ω) of y(n)=g(n)+αₛ(n)βₛ(n) is

$$Y ( ω ) = G ( ω ) + \frac{1}{4} {\sum }_{{k}_{0} , {k}_{1} = 0}^{1} A ( ω + π k ) + {( - 1 )}^{{k}_{0} + {k}_{1}} B ( ω + π k ) \qquad ( 4 )$$

FIG. 3D shows Y(ω) of the sample “clown” image from the Bayer pattern CFA data of FIGS. 3A-C represented as a sum of g(n) (i.e., green), αₛ(n) (i.e., red difference signal), and βₛ(n) (i.e., blue difference signal). Note that the rectangular subsampling lattice of the Bayer pattern CFA shifts the spectral content of αₛ(n) and βₛ(n) (“aliasing”), and also induces spectral copies 301 centered about the set of frequencies ωε{(0,π), (π,0), (π,π)} (“imaging”). In some embodiments of the present invention, it is possible to take advantage of the lowpass nature of these subsampled difference signals to separate the color components of data observed through a color filter array, as described in more detail below.

In one aspect of the present invention, it is recognized that a separable wavelet transform is equivalent to a set of convolutions corresponding to directional filtering in two dimensions followed by a separable dyadic decimation about both spatial frequency axes. The application of these steps to y(n) is detailed in FIGS. 3E-H, which shows the log-magnitude spectrum after filtering according to the standard directional wavelet filterbank low- and highpass transfer functions H_{LL}(ω), H_{HL}(ω), H_{LH}(ω), and H_{HH}(ω), respectively, and FIGS. 3I-L which shows the result of subsequent decimation.

The application of each filter function (e.g., H_{LL}(ω), etc.) and subsequent decimation is equivalent to a remapping of each color channel's spatial frequency content to the origin, and a subsequent dilation of each spectrum. In one aspect of the present invention, it is recognized that if the spectral content of the difference channels is sufficiently low relative to that of the green channel, the application of such filter functions and subsequent decimation provides a method for effectively separating the spectral energy of individual color components, as shown in FIGS. 3M-P.

### Wavelet Analysis of Subsampled Sequences

In one aspect of the present invention, it is recognized that wavelet analysis may be used to recover spectra information of a subsampled image. In some embodiments, such wavelet analysis may be performed using Daubechies wavelets. Suppose that, as in the case of Daubechies wavelets, the directional transfer functions {H_{LL}, H_{LH}, H_{HL}, H_{HH}} comprise a filterbank satisfying the Smith-Barnwell (S-B) condition. In this case, the) subsampled difference images αₛ(n) and βₛ(n) may be conveniently represented in the wavelet domain. An example of this representation is described below in the univariate domain, though this representation may be extended to any number of dimensions.

In considering a univariate wavelet representation of the difference images, let {H_{L}(ω), H_{H}(ω)} be an S-B filter pair such that the S-B condition of H_{H}(ω)=−e^{-jωm}H_{L}(−ω+π), where m is an odd integer is satisfied, and let dᵢε{L,H} index the filter passband of the decomposition at level i. For a sequence γ(n) and its corresponding even-subsampled version

$${γ}_{s} ( n ) := \frac{1}{2} [ γ ( n ) + {( - 1 )}^{n} γ ( n ) ] ,$$

the first-level filterbank decomposition of γₛ(n), denoted W_{d}_{₁}(ω), is equivalent to the sum of the corresponding decompositions of γ(n) and (−1)ⁿγ(n) (denoted ½ W_{d}_{₁}′(ω) and ½ W_{d}_{₁}″(ω), respectively). These decompositions in turn are related to the spectrum Γ(ω) of γ(n) as:

$${W}_{{d}_{1}}^{′} ( ω ) = \frac{1}{2} [ {H}_{{d}_{1}} ( \frac{ω}{2} ) Γ ( \frac{ω}{2} ) + {H}_{{d}_{1}} ( \frac{ω}{2} + π ) Γ ( \frac{ω}{2} + π ) ] \\ \begin{matrix}{W}_{{d}_{1}}^{″} ( ω ) = \frac{1}{2} [ {H}_{{d}_{1}} ( \frac{ω}{2} + π ) Γ ( \frac{ω}{2} ) + {H}_{{d}_{1}} ( \frac{ω}{2} ) Γ ( \frac{ω}{2} + π ) ] \\ = {c}_{{d}_{1}} \frac{ω}{4} [ {H}_{{d}_{1}^{- 1}}^{*} ( \frac{ω}{2} ) Γ ( \frac{ω}{2} ) + {H}_{{d}_{1}^{- 1}}^{*} ( \frac{ω}{2} + π ) Γ ( \frac{ω}{2} + π ) ] ,\end{matrix} \qquad ( 5 )$$

where * denotes the complex conjugate, and for m odd:

$${d}_{1}^{- 1} = \{ \begin{matrix}H & if {d}_{1} = L \\ L & if {d}_{1} = H ,\end{matrix} \\ {c}_{{d}_{1}} ( ω ) = \{ \begin{matrix}{e}^{jω m} & if {d}_{1} = L \\ - {e}^{- j ω m} & if {d}_{1} = H ..\end{matrix} \qquad ( 6 )$$

Although this example is given using Daubechies wavelets, the invention is not limited to any particular set or type of wavelets. Rather, the present invention may include any arrangement or combination of any filterbanks.

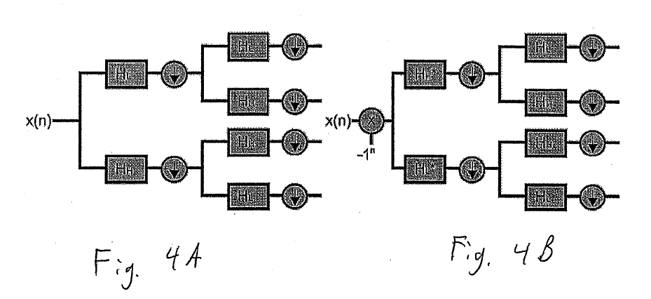

In some implementations, these equations may be simplified by using Haar wavelets. For the case of the Haar wavelet, we have H_{d}_{₁}=c_{d}_{₁}H_{d}_{₁}*, and hence by construction the scaling coefficient of (−1)ⁿγ(n) is equal to the wavelet coefficient of γ(n), and vice-versa. It follows that the multi-level wavelet decomposition of (−1)ⁿγ(n) is equivalent to the same multi-level wavelet packet decomposition of γ(n), but in the reverse order of coarseness to fineness. An example of this filterbank structure equivalence is shown in FIGS. 4A and B.

### Wavelet-Based CFA Image Demosaicing

In addition to providing a natural way to recover the spectra associated with individual color components of a given CFA image y(n), filterbank decompositions also provide a simple formula for reconstructing a representation of the complete (i.e., non-subsampled) image x(n). Returning to describe the two-dimensional application of filterbank decompositions to a captured image in accordance with some embodiments of the present invention, let w_{d}_{₁}_{,d}_{₂}^{y}, w_{d}_{₁}_{,d}_{₂}^{g}, w_{d}_{₁}_{,d}_{₂}^{α}, w_{d}_{₁}_{d}_{₂}^{β} be the two-level wavelet (packet) transforms via S-B filterbanks of y(n), g(n), α(n), β(n), respectively, where d₁, d₂ indicates the filter orientation. Then (as may be seen from the example of FIG. 3, particularly FIG. 3D), if the spectral content of the difference channels is sufficiently lowpass (i.e., a sufficient amount of difference information is in the low frequency regions of FIGS. 3B and C) with respect to that of the green color channel, the following approximations will be accurate:

$$\begin{matrix}{w}_{LL , LL}^{y} = {w}_{LL , LL}^{g} + \frac{1}{4} [ {w}_{LL , LL}^{α} + {w}_{L \tilde{H} , LL}^{α} + {w}_{\tilde{H} L , LL}^{α} + {w}_{\tilde{H} \tilde{H} , LL}^{α} ] + \\ \frac{1}{4} [ {w}_{LL , LL}^{β} - {w}_{L \tilde{H} , LL}^{β} - {w}_{\tilde{H} L , LL}^{β} + {w}_{\tilde{H} \tilde{H} , LL}^{β} ] \\ \approx {w}_{LL , LL}^{g} + \frac{1}{4} {w}_{LL , LL}^{α} + \frac{1}{4} {w}_{LL , LL}^{β} ,\end{matrix} \qquad ( 7 )$$

where ˜ denotes reversal of a sequence. Similarly,

$${w}_{L \tilde{H} , LL}^{y} \approx {w}_{\tilde{H} L , LL}^{y} \approx \frac{1}{4} [ {w}_{LL , LL}^{β} - {w}_{LL , LL}^{α} ] \\ {w}_{\tilde{H} \tilde{H} , LL}^{y} \approx \frac{1}{4} [ {w}_{LL , LL}^{α} + {w}_{LL , LL}^{β} ] . \qquad ( 8 )$$

In some embodiments of the present invention, a demosaicing algorithm may assume that these approximations hold. In practice, these approximations may be accurate for a majority of captured images. In such embodiments, a representation of x(n) may be recovered from its wavelet coefficients as follows:

$${\hat{w}}_{{d}_{1} , {d}_{2}}^{g} = \{ \begin{matrix}{w}_{LL , LL}^{y} - {w}_{\tilde{H} \tilde{H} , LL}^{y} & if {d}_{1} = {d}_{2} = LL \\ {w}_{{d}_{1} , {d}_{2}}^{y} & if {d}_{2} \neq LL \\ 0 & otherwise\end{matrix} \\ {\hat{w}}_{{d}_{1} , {d}_{2}}^{α} = \{ \begin{matrix}2 {w}_{\tilde{H} \tilde{H} , LL}^{y} - {w}_{L \tilde{H} , LL}^{y} - {w}_{\tilde{H} L , LL}^{y} & if {d}_{1} = {d}_{2} = LL \\ 0 & otherwise\end{matrix} \\ {\hat{w}}_{{d}_{1} , {d}_{2}}^{β} = \{ \begin{matrix}2 {w}_{\tilde{H} \tilde{H} , LL}^{y} + {w}_{L \tilde{H} , LL}^{y} + {w}_{\tilde{H} L , LL}^{y} & if {d}_{1} = {d}_{2} = LL \\ 0 & otherwise ,\end{matrix} \qquad ( 9 )$$

where ̂ indicates an approximation of a value from the original image. It should be recognized that although the above example is described using two-level wavelet transforms of the original CFA data, the invention is not limited to two-level wavelet transforms. Rather, embodiments of the present invention may include any number of levels of any arrangement or combination of filterbank transforms/filterbank coefficients. For example, in some embodiments, filterbank coefficients may include complete and/or overcomplete filterbanks.

### Wavelet-Based CFA Image Denoising

Wavelet-based methods for image denoising have proved immensely popular in the literature, in part because the resultant shrinkage or thresholding estimators ŵ are simple and computationally efficient, yet they may enjoy excellent theoretical properties and adapt well to spatial inhomogeneities. However, typical techniques have been designed for grayscale or complete color image data, and hence have been applied after demosaicing.

Although it may be possible to model noisy difference images in the wavelet domain directly within the statistical framework of missing data, the computational burden of doing so may be severe. However, in one aspect of the present invention, it is recognized that the wavelet analysis described above suggests a simpler scheme.

First, note that in some embodiments, when d₂≠LL, it can be expected that the wavelet coefficients ŵ estimated by some shrinkage operator will satisfy the relationship ŵ_{d}_{₁}_{,d}_{₂}^{g}≈ŵ_{d}_{₁}_{,d}_{₂}^{y}. Furthermore, equation (7) implies that w_{LL,LL}^{y} represents the {LL, LL} subband coefficients of:

$$g ( n ) + \frac{1}{4} α ( n ) + \frac{1}{4} β ( n ) = \frac{1}{2} g ( n ) + \frac{1}{4} r ( n ) + \frac{1}{4} b ( n ) , \qquad ( 10 )$$

which provides a means of estimating an image's luminance component (which in turn exhibits statistics similar to a grayscale image). Thus, in some embodiments, ŵ_{LL,LL}^{y} may be obtained via a standard denoising strategy. Finally, the quantities of equations shown at (8) correspond to {LL, LL} subband coefficients from the difference images r(n)−b(n) and of α(n)+β(n). As smoothed approximate versions of images themselves, in some embodiments, they may be amenable to standard wavelet-based denoising algorithms.

### Process Example

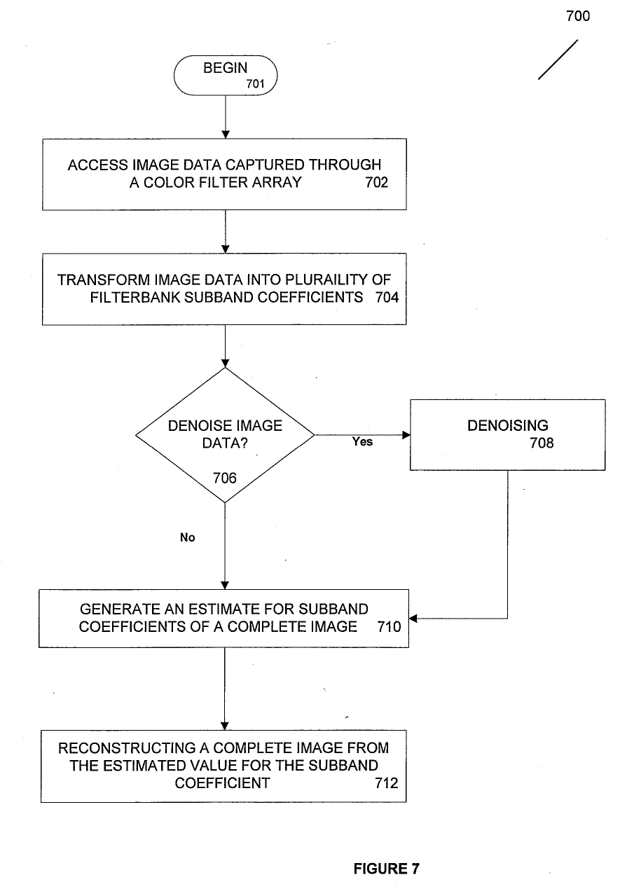

FIG. 7 illustrate an example of a process implementing some of the features discussed above. In particular, FIG. 7, shows process 700 initiated at 701 by accessing image data captured through a color filter array at 702. One should appreciate that the image data may be received directly from a CMOS sensor for example and transmitted to an image processor as discussed with respect to certain system embodiments above. One should also appreciate that the image data may be stored for later access and the medium upon which the data is stored may be transmitted or physically transported to a system upon which the image data is processed.

Once the image data has been accessed, it is transformed into a plurality of filterbank subband coefficients by passing the image data through filterbanks at 704. The filterbanks may be adapted to conform to the Smith-Barnwell properties and enabling representation of the transformed image data as wavelets. In particular, Haar and Daubechies wavelet representations may be used, although in other alternatives different classes of wavelet transforms are contemplated.

Illustrated in FIG. 7 is a decision node where a determination of whether donoising will occur is made at 706. In 706 Yes denoising schemes may be employed to reduce the image data to a form free or reduced from noise, at 708. In particular, wavelet based denoising may be employed. One should appreciate based on the transformation process that denoising can occur before, in conjunction with, or after demosaicing and need not take place in the same order described in the example of process 700, shown in FIG. 7. In 706 No, no denoising algorithm is employed.

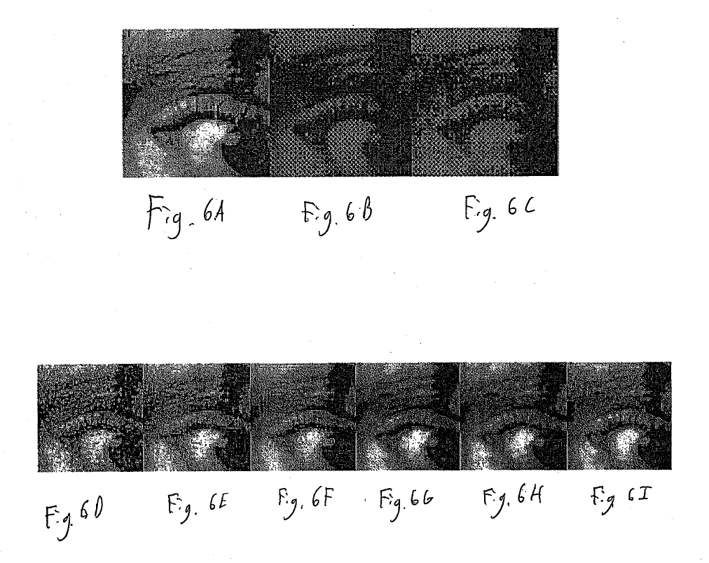

At 710, an estimate is generated for subband coefficients of a complete image, and the value of the estimated subband coefficient is determined from values of the plurality of subband coefficients of the transformed image data, whether denoised at 706 Yes or not at 706 No. At 712, a complete image is reconstructed from the value of the estimated subband coefficient, yielding images as shown in, for example FIG. 6I.

One should appreciate that process 700 is shown by way of example and that certain steps may be performed in an order different than presented, and certain steps may be omitted and/or different steps included in performing an image processing process according to different embodiment of the invention.

### Experimental Results

In order to test the proposed denoising and demosaicing schemes for CFA data, both separately as well as in tandem, a variety of numerical experiments was performed using widely available test images commonly referred to as “Clown” and “Lena.” These images were first subsampled according to the Bayer pattern and then corrupted with additive white Gaussian noise of mean zero. Reconstruction methods were implemented using separable Daubechies wavelets, with cycle-spinning employed for the first-level decomposition, and the nondecimated wavelet transform for the subsequent.

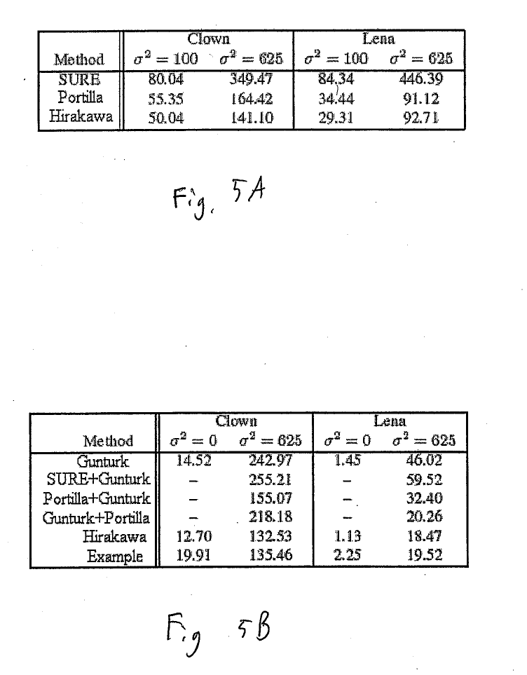

First, the corrupted data were used to compare the performance of three wavelet-based algorithms for denoising: the SURE Shrink method applied independently to each wavelet coefficient; a model based on scale mixtures of Gaussians applied to each of the de-interlaced color channels of the CFA image in turn; and the wavelet coefficient model describing statistically estimating wavelet values at each location of a wavelet transform of an image from wavelet values of nearby locations. Denoising was performed using a total of three decomposition levels and a shrinkage operator, with the noise variance σ² estimated from the {HH, HH} subband. FIG. 5A illustrates a table comparing the mean-square error (MSE) of the various denoised CFA images.

By treating the denoised output ŵ_{d}_{₁}_{,d}_{₂}^{y} as input to the demosaicing algorithm described above (e.g., with respect to equation (9)), an example embodiment of the present invention comprising combined denoising and demosaicing was obtained and subsequently tested. FIG. 5B illustrates a table showing the average SCIELAB distance of the output images from the original input images for this example embodiment as well as several alternative methods; a method using the Shrink SURE method followed by the method described by Gunturk, et. al.; a method using the method of Portilla, et. al. followed by the method of Gunturk, et. al.; a method using the method of Gunturk, et. al., followed by the method of Portilla, et. al.; and a method of Hirakawa, et. al.

FIG. 6A shows the original “clown” image. FIG. 6B shows the Bayer pattern CFA data captured from the original image of FIG. 6A. FIG. 6C shows the CFA image of FIG. 6B with added noise. FIGS. 6D-I illustrate the results of applying the methods listed in the table of FIG. 5B to the data of FIG. 6C, in the order of the table. In some embodiments, performance of the tested techniques produced results substantially comparable to prior-art methods but with significantly reduced computational cost as can be seen by comparing FIGS. 6D-H (i.e., output of the prior art methods) with FIG. 61 (i.e., output of an example embodiment of the present invention). In some embodiments, performance of methods in accordance with the present invention improves noticeably upon the introduction of noise, and offers enhanced edge preservation relative to alternatives that treat denoising and demosaicing separately.

Results indicate that embodiments of the present invention perform at least on a par with the state of the art with far lower computational cost, and provide a versatile, effective, and low-complexity solution to the problem of interpolating color filter array data observed in noise. Denoising algorithms and demosaicing algorithms may be combined using the above described wavelet analysis to allow for further optimization of wavelet-based compression schemes in conjunction with denoising and demosaicing of CFA data.

### Additional Considerations: Joint Denoising/Demosaicking

As the general trend of increased image resolution continues due to prevalence of multimedia, the importance of interpolation is de-emphasized while the concerns for computational efficiency, noise, and color fidelity play an increasingly prominent role in the decision making of a digital camera architect. For instance, the interpolation artifacts become less noticeable as the size of the pixel shrinks with respect to the image features, while the decreased dimensionality of the pixel sensors on the complementary metal oxide semiconductor (CMOS) and charge coupled device (CCD) sensors make the pixels more susceptible to noise. Photon-limited influences are also evident in low-light photography, ranging from a specialty camera for precision measurement to indoor consumer photography.

Sensor data, which can be interpreted as subsampled or incomplete image data, undergo a series of image processing procedures in order to make the image data displayable. However, these same steps are also responsible for amplifying the distortions introduced at the image sensor. Specifically, the demosaicking step is a major source of conflict between the image processing pipeline and image sensor noise characterization because the interpolation methods give high priority to preserving the sharpness of edges and textures. In the presence of noise, noise patterns may form false edge structures, and therefore the distortions at the output are typically correlated with the signal in a complicated manner that makes noise modeling mathematically intractable. Thus, it is natural to conceive of a rigorous tradeoff between image interpolation and image denoising.

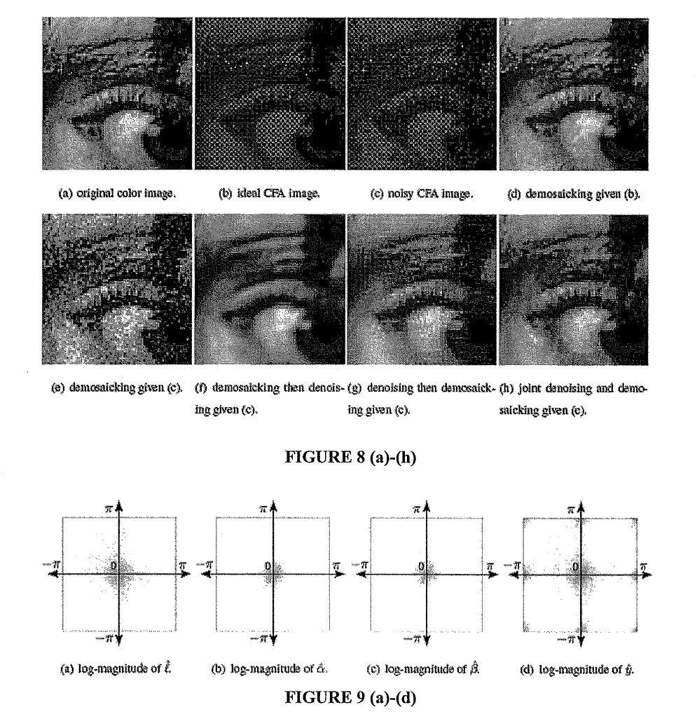

To illustrate, FIG. 8(a) shows a typical color image. Suppose we simulate the noisy sensor observation by subsampling this image according to a CFA pattern (FIG. 8(b)) and corrupting with noise (FIG. 8(c)). While state-of-the-art demosaicking methods do an impressive job in estimating the full-color image given ideal sensor data (FIG. 8(d)), the interpolation may also amplify the noise in the sensor measurements, as demonstrated in FIG. 8(f). The state-of-the-art denoising methods applied to FIG. 8(f) yield unsatisfactory results (FIG. 8(g)), suggesting a lack of coherent strategy to address interpolation and noise issues jointly. For comparison, the output from one example of a joint demosaicking and denoising method is shown in FIG. 8(h) with observable advantages. FIG. 8(e) shows demosaicing of 8(c).

According to one aspect, the problem of estimating the complete noise-free image signal of interest given a set of incomplete observation of pixel components that are corrupted by noise may be approached statistically from a point of view of Bayesian statistics, that is modeling of the various quantities involved in terms of priors and likelihood. Three examples of design regimes that will be considered here can be thought of as a simultaneous interpolation and image denoising, though one should appreciate the wider scope, in the sense that modeling the image signal, missing data, and the noise process explicitly yield insight into the interplay between the noise and the signal of interest. Presented, through example, is a basis for generalization of the image signal models to the noisy subsampled case, and building blocks for manipulating such data.

Some embodiments provide a number of advantages to the proposed estimation schemes over the obvious alternative, which is the serial concatenation of the independently designed interpolation and image denoising algorithms. For example, the inherent image signal model assumptions underlying the interpolation procedure may differ from those of the image denoising. This discrepancy is not only contradictory and thus inefficient, but also triggers mathematically intractable interactions between mismatched models. Specifically, interpolating distorted image data may impose correlation structures or bias to the noise and image signal in an unintended way. Furthermore, a typical image denoising algorithm assumes a statistical model for natural images, not that of the output of interpolated image data. While grayscale and color image denoising techniques have been suggested, removing noise after demosaicking, however, is impractical. Likewise, although many demosaicking algorithms developed in the recent years yield impressive results in the absence of sensor noise, the performance is less than desirable in the presence of noise.

In one embodiment, it is important to characterize the noise in an image sensor. The CMOS photodiode active pixel sensor typically uses a photodiode and three transistors, all major sources of noise. The CCD sensors rely on the electron-hole pair that is generated when a photon strikes silicon. A detailed investigation of the noise source is not discussed, however, studies suggest that z: [symbol] → [symbol] , the number of photons encountered during an integration period (duration between resets), is a Poisson process

[symbol]

$$p ( z ( n ) \vert y ( n ) ) = \frac{{e}^{- y ( n )} {y ( n )}^{z ( n )}}{z ( n ) !} ,$$

where nε [symbol] is the pixel location index, and y(n) is the expected photon count per integration period at location n, which is linear with respect to the intensity of the light. Note E[z(n)|y(n)]=y(n) and E[z²(n)−E[z(n)|y(n)]²|y(n)]=y(n). Then, as the integration period increases, p(z(n)|y(n)) converges weakly to N(y(n),y(n)), or

z(n)≈y(n)+\sqrt{y(n)}ε(n), (I)

where

$$ε {∼}^{i . i . d .} 𝒩 ( 0 , 1 )$$

is independent of y. This approximation is justifiable via a straightforward application of central limit theorem to the binomial distribution. The noise term, \sqrt{y(n)}ε(n), is commonly referred to as the shot noise.

In practice of one embodiment, the photodiode charge (e.g. photodetector readout signal) is assumed proportional to z(n), thus we interpret y(n) and z(n) as the ideal and noisy sensor data at pixel location n, respectively. For a typical consumer-grade digital camera, the approximation in (I) is reasonable. The significance of (I) is that the signal-to-noise ratio improves for a large value of y(n) (e.g. outdoor photography), while for a small value of y(n) (e.g. indoor photography) the noise is severe. To make the matters worse, human visual response to the light y(n) is often modeled as

$$\sqrt[3]{y ( n )} ,$$

suggesting a heightened sensitivity to the deviation in the dark regions of the image. To see this, the perceived noise magnitude is proportional to:

$$\sqrt[3]{z ( n )} - \sqrt[3]{y ( n )} = \sqrt[3]{y ( n ) + \sqrt{y ( n )} ε ( n )} - \sqrt[3]{y ( n )} ,$$

which is a monotonically decreasing function with respect to y(n) for a fixed value of ε(n).

In some attempts, efforts to address signal-dependent noise in (I) lags behind those of image interpolation and image denoising for additive white Gaussian noise (AWGN). A standard technique for working with signal-dependent noise is to apply an invertible nonlinear operator γ(•) on z such that signal and noise are (approximately) decoupled. That is,

γ(z)|γ(y)˜ [symbol] (γ(y),σ²)

for some constant σ². Homomorphic filtering is one such operator designed with monotonically-increasing nonlinear pointwise function. γ: [symbol] → [symbol] . The Haar-Fisz transform γ: [symbol] × [symbol] → [symbol] × [symbol] is a multiscale method that asymptotically decorrelates signal and noise. In any case, a signal estimation technique (assuming AWGN) is used to estimate γ(y) given γ(z), and the inverse transform γ⁻¹(•) yields an estimate of y. The advantage of this approach is the modularity of the design of γ(•) and the estimator. The disadvantage is that the signal model assumed for y may not hold for γ(y) and the optimality of the estimator (e.g. minimum mean squared error estimator) in the new domain does not translate to optimality in the rangespace of y, especially when γ(•) significantly deviates from linearity.

An alternative to decorrelation is to approximate the noise standard deviation, \sqrt{y(n)}. The AWGN noise model is effectively a zero-th order Taylor expansion of the Poisson process; an affine noise model is the first order Taylor expansion of (I). In practice, these approximations yield acceptable performance because the CMOS sensors operate on a relatively limited dynamic range, giving validity to the Taylor assumption (when the expansion is centered about the midpoint of the operating range). The human visual system can also tolerate a greater degree of error in the brighter regions of the image, allowing for more accurate noise characterization for small values of y (at the cost of poorer characterization for higher rangespace of y). Alternatively, empirical methods that address signal-dependent noise take a two-step approach. First, a crude estimate of the noise variance at each pixel location n is found; second, conditioned on this noise variance estimate, we assume that the signal is corrupted by signal-independent noise. A piecewise AWGN model achieves a similar approximation.

Methods that work with the posterior distribution of the coefficients of interests, such as Markov chain Monte Carlo and importance sampling, either have a slow convergence rate or require a large number of observations. Emerging frameworks in Bayesian analysis for Poisson noise yield an asymptotic representation of the Poisson process in the wavelets domain, but the manipulation of data in this class of representation is extremely complicated.

The estimation of the mean y given the Poisson process z is not a well-understood problem; and existing methods use variations of AWGN models to address the Poisson noise. Hence, while acknowledging inadequacies, some embodiment employ:

$$z ( n ) = y ( n ) + ε ( n ) , \\ where \\ ε {∼}^{i . i . d .} 𝒩 ( 0 , {σ}_{ε}^{2} ) . \qquad ( II )$$

Taking a closer look at the sampling scheme shows the structure of aliasing induced by the Bayer color filter array. The estimation of missing pixel components given observed pixel components is generally an ill-posed problem. By assuming that the image signals are highly structured, however, the signal-of-interest may be identical in a lower-dimensional subspace that can be represented by the subspace spanned by the color filter array. Thus, although the loss of data at the hardware interface is inevitable, the loss of information due to sampling may be limited. Fourier analysis and aliasing serve as a measure of loss of information, and motivate joint modeling and manipulation of subsampled data and noise (which will subsequently be fine-tuned)

For some embodiments, images have an image pixel value, x(n)=(x₁(n), x₂(n), x₃(n))^{T} that is a vectored value at the pixel position nε [symbol] , typically expressed in terms of RGB coordinates, respectively. By inspection, the corresponding complete red, green, and blue images contain redundant information with respect to edge and textural formation, reflecting the fact that the changes in color at the object boundary is secondary to the changes in intensity. It follows from the (de-)correlation of color content at high frequencies that the difference images (e.g. red-green, blue-green) exhibit rapid spectral decay relative to monochromatic image signals (e.g. gray, red, green), and are therefore slowly-varying over spatial domain. Such heuristic intuitions are further backed by the human physiology—the contrast sensitivity function for the luminance channel in human vision is typically modeled with a much higher pass-band than that of the chrominance channels.

In one example, let c(n)=(c₁(n), c₂(n), c₃(n))^{T}ε{(1, 0, 0)^{T}, (0, 1, 0)^{T}, (0, 0, 1)^{T}} be a CFA coding such that the noise-free sensor data can be written as an inner product, y(n)=c^{T}(n)×(n). Given that it is a convex combination, we may then decompose y(n) in the following manner:

$$y ( n ) = {c}_{1} ( n ) {x}_{1} ( n ) + {c}_{2} ( n ) {x}_{2} ( n ) + {c}_{3} ( n ) {x}_{3} ( n ) \\ = {c}_{1} ( n ) {x}_{1} ( n ) + ( 1 - {c}_{1} ( n ) - {c}_{3} ( n ) ) {x}_{2} ( n ) + {c}_{3} ( n ) {x}_{3} ( n ) \\ = {c}_{1} ( n ) [ {x}_{1} ( n ) - {x}_{2} ( n ) ] + {c}_{3} ( n ) [ {x}_{3} ( n ) - {x}_{2} ( n ) ] + {x}_{2} ( n ) \\ = {c}_{1} ( n ) α ( n ) + {c}_{3} ( n ) β ( n ) + {x}_{2} ( n ) , \qquad ( III )$$

where the difference images α(n)=x₁(n)−x₂(n) and β(n)=x₃(n)−x₂(n) are approximations for the chrominance channels. In other words, the convex combination above can be thought of as the summation of x₂(n) with the subsampled difference images, c₁(n)α(n) and c₃(n)β(n); as their sum is equal to the sensor data. It follows from the composition of the dyadic decimation and interpolation operators induced by the Bayer sampling pattern that ̂y (ω), the Fourier transform of sensor data y(n), is a sum of \hat{x}₂(ω) and the spectral copies of \hat{α}(ω) and β̂(ω):

$$\hat{y} ( ω ) = {x}_{2} ( ω ) + \frac{1}{4} [ \begin{matrix}\begin{matrix}\begin{matrix}( \hat{α} + \hat{β} ) ( ω ) + \\ ( \hat{α} - \hat{β} ) ( ω - {( π , 0 )}^{T} ) +\end{matrix} \\ ( \hat{α} - \hat{β} ) ( ω - {( 0 , π )}^{T} ) +\end{matrix} \\ ( \hat{α} + \hat{β} ) ( ω - {( π , π )}^{T} )\end{matrix} ] \\ = \hat{l} ( ω ) + \frac{1}{4} [ \begin{matrix}\begin{matrix}( \hat{α} - \hat{β} ) ( ω - {( π , 0 )}^{T} ) + \\ ( \hat{α} - \hat{β} ) ( ω - {( 0 , π )}^{T} ) +\end{matrix} \\ ( \hat{α} + \hat{β} ) ( ω - {( π , π )}^{T} )\end{matrix} ] , \qquad ( IV )$$

where, without loss of generality, the origin is fixed on the first color, c(0,0)=(1, 0, 0)^{T}, and

$$\hat{l} = {\hat{x}}_{2} ( ω ) + \frac{1}{4} \hat{α} ( ω ) + \frac{1}{4} \hat{β} ( ω ) = \frac{1}{4} {\hat{x}}_{1} ( ω ) + \frac{1}{2} {\hat{x}}_{2} ( ω ) + \frac{1}{4} {\hat{x}}_{3} ( ω ) , \qquad ( V )$$

is an approximation to the luminance channel.

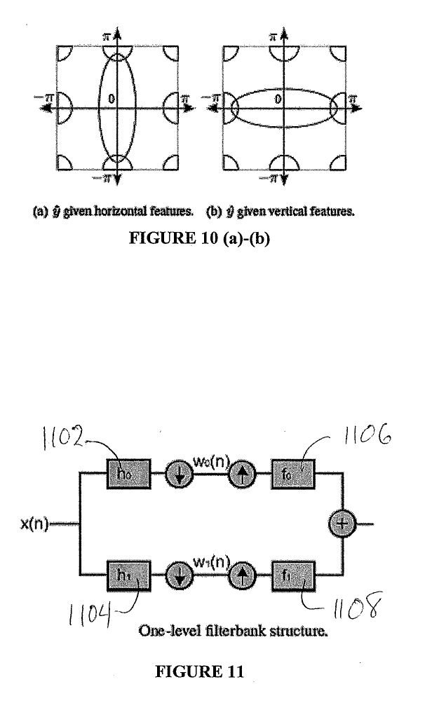

The representation of sensor data (IV) in terms of luminance l and difference images α and β is convenient because α and β are typically sparse in the Fourier domain. To see this by example, consider FIG. 9(a)-9(d), in which the log-magnitude spectra of a typical color image, “clown,” is shown. The high-frequency components, a well-accepted indicator for edges, object boundaries, and textures, are easily found in FIG. 9(a). In contrast, the spectra in FIGS. 9(b-c) reveal that α and β are low-pass, which support the slowly-varying nature of the signals discussed above. Estimating a lower bandwidth signal from its sparsely subsampled versions is less complex, since it is less subject to aliasing. FIG. 10(a)-(b) shows aliasing structure in local spectra and conditioned local image features of the surrounding. In one example, it follows from FIG. 10 that a Fourier domain representation of sensor data similar to what is illustrated in FIG. 9(d)—the spectral copies of â−\hat{β} centered around (π,0)^{T} and (0,π)^{T} overlap with the baseband \hat{l}, while â+\hat{β} centered around (π,π)^{T} remain alias-free.

There exists no straightforward global strategy such that we recover unaliased \hat{l} because both spectral copies centered around (π,0)^{T} and (0,π)^{T} are aliased with the baseband \hat{l}. However, the local image features of the baseband, \hat{l}, exhibit a strong directional bias, and therefore either (\hat{α}−\hat{β})(ω−(π,0)^{T}) or (\hat{α}−\hat{β})(ω−(0,π)^{T}) is locally recoverable from the sensor data. In one example, this observation motivates nonlinear processing that is locally adaptive—in fact, most existing demosaicking methods can be reexamined from this perspective. FIG. 10(a)-(b) illustrates examples of an estimated local aliasing pattern. The locally horizontal images suffer from aliasing between \hat{l} and (\hat{α}−\hat{β})(ω−(π,0)^{T}) while (\hat{α}−\hat{β})(ω−(0,π)^{T}) remains relatively intact. Conversely, locally vertical images suffer from aliasing between \hat{l} and (â−\hat{β})(ω−(0,π)^{T}) while (\hat{α}−\hat{β})(ω−(π,0)^{T}) is clean. On a sidenote, locally diagonal image features, which are often ignored by the demosaicking algorithm designs, do not interfere with (\hat{α}−\hat{β})(ω−(π,0)^{T}) and (\hat{α},\hat{β})(ω−(0,π)^{T}), making the reconstruction of diagonal features a trivial task, in some embodiments.

Let z(n) be the noisy sensor data,

$$z ( n ) = y ( n ) + ε ( n ) = {c}_{1} ( n ) α ( n ) + {c}_{3} ( n ) β ( n ) + {x}_{2} ( n ) + ε ( n ) , \\ where \\ ε {∼}^{i . i . d .} 𝒩 ( 0 , {σ}_{ε}^{2} ) . \qquad ( VI )$$

In one example, the Fourier transform of a noisy observation is

$$\hat{z} ( ω ) = \hat{l} ( ω ) + \frac{1}{4} [ \begin{matrix}\begin{matrix}( \hat{α} - \hat{β} ) ( ω - {( π , 0 )}^{T} ) + \\ ( \hat{α} - \hat{β} ) ( ω - {( 0 , π )}^{T} ) +\end{matrix} \\ ( \hat{α} + \hat{β} ) ( ω - {( π , π )}^{T} )\end{matrix} ] + \hat{ɛ} ( ω ) .$$

In other words, the sensor data is the baseband luminance image \hat{l} distorted by the noise \hat{ε} and aliasing due to spectral copies of \hat{α} and \hat{β}, where \hat{ε}, \hat{α}, and \hat{β} are conditionally normal. One example of a unified strategy to demosaicking and denoising, therefore, is to design an estimator that suppresses noise and attenuates aliased components simultaneously. In one embodiment, this is accomplished via a spatially-adaptive linear filter whose stop-band contains the spectral copies of the difference images and pass-band suppresses noise.

As image signals are highly non-stationary/inhomogeneous and thus an orthogonal filterbank (or wavelet packet) expansion for sparsely sampled signal would prove useful in some embodiments.

In one example, consider first a one-dimensional signal x: [symbol] → [symbol] . A one-level filterbank structure defined by filters {h₀, h₁, f₀, f₁} is shown in FIG. 11. It is a linear transformation composed of convolution filters and decimators. The channel containing the low-frequency components is often called approximation (denoted w₀^{x}(n)), and the other containing the high-frequency components is referred to as the detail (denoted w₁^{v}(n)). The decomposition can be nested recursively to gain more precision in frequency. The approximation and detail coefficients from one-level decomposition can be analyzed in the Fourier domain as:

$${\hat{w}}_{i}^{x} ( ω ) = \frac{1}{2} [ {\hat{h}}_{i} ( \frac{ω}{2} ) \hat{x} ( \frac{ω}{2} ) + {\hat{h}}_{i} ( \frac{ω}{2} - π ) \hat{x} ( \frac{ω}{2} - π ) ] ,$$

where iε{0,1}. With a careful choice of filters {h₀(1102), h₁(1104), f₀(1106), f₁(1108)}, the original signal, x(n) can be recovered exactly from the filterbank coefficients w₀^{x}(n) and w₁^{x}(n). To see this, consider the example of the reconstruction of one-level filterbank, as in FIG. 11. The transfer function of the system (or the reconstructed signal x^{rec}(n)) has the following form in the frequency domain:

$${\hat{x}}^{rec} ( ω ) = {\hat{f}}_{0} ( ω ) {\hat{w}}_{0}^{x} ( 2 ω ) + {\hat{f}}_{1} ( ω ) {\hat{w}}_{1}^{x} ( 2 ω ) \\ = \frac{1}{2} [ \begin{matrix}{\hat{f}}_{0} ( ω ) {\hat{h}}_{0} ( ω ) + \\ {\hat{f}}_{1} ( ω ) {\hat{h}}_{1} ( ω )\end{matrix} ] \hat{x} ( ω ) + \frac{1}{2} [ \begin{matrix}{\hat{f}}_{0} ( ω ) {\hat{h}}_{0} ( ω - π ) + \\ {\hat{f}}_{1} ( ω ) {\hat{h}}_{1} ( ω - π )\end{matrix} ] \hat{x} ( ω - π ) .$$

In other words, the output is a linear combination of the filtered versions of the signal \hat{x}(ω) and a frequency-modulated signal \hat{x}(ω−π). The structure in FIG. 11 is called a perfect reconstruction filterbank if

\hat{f}₀(ω)ĥ₀(ω)+\hat{f}₁(ω)ĥ₁(ω)=2

\hat{f}₀(ω)ĥ₀(ω−π)+\hat{f}₁(ω)ĥ₁(ω−π)=0.

In other words, the filters corresponding to \hat{x}(ω) constitute a constant, whereas the filters corresponding to the aliased version is effectively a zero.

A large body of literature exists on designing a set of filters {h₀, h₁, f₀, f₁} that comprise a perfect reconstruction filterbank including wavelet packets belonging to a class of filterbanks arising from the factorizing filters satisfying the Nyquist condition (Smith-Barnwell). In one example, the following are met by construction:

ĥ₁(ω)=−e^{-jωm}ĥ₀(−ω−π)

\hat{f}₀(ω)=ĥ₁(ω−π)

\hat{f}₁(ω)=−ĥ₀(ω−π). (VII)

In other words, h₁ is a time-shifted, time-reversed, and frequency-modulated version of h₀; and f₀ and f₁ are time-reversed versions of h₀ and h₁, respectively. One may define modulated signal and subsampled signal of x(n), respectively, as

$${x}_{m} ( n ) = {( - 1 )}^{n} x ( n )$$

$${x}_{s} ( n ) = \frac{1}{2} [ x ( n ) + {x}_{m} ( n ) ] = \{ \begin{matrix}x ( n ) & n even \\ 0 & n odd .\end{matrix}$$

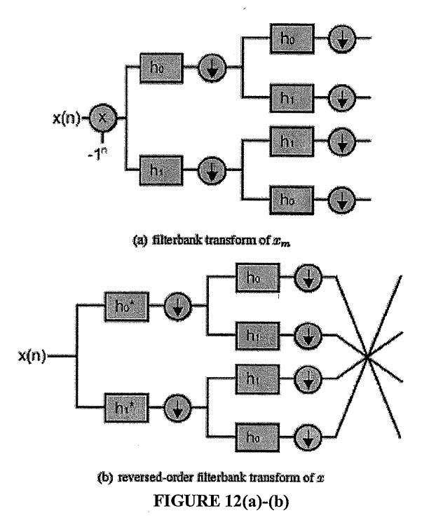

To derive an explicit filterbank representation of xₛ(n), we are interested in characterizing the relationship between filterbank coefficients of x(n) and xₘ(n). Let w₀^{x}^{ₘ}(n) and w₁^{x}^{ₘ}(n) be the approximation and detail coefficients of the one-level filterbank decomposition of (−1)ⁿx(n). Then substituting into (VII) we obtain

$${\hat{w}}_{0}^{{x}_{m}} ( ω ) = \frac{1}{2} [ {\hat{h}}_{0} ( \frac{ω}{2} ) \hat{x} ( \frac{ω}{2} - π ) + {\hat{h}}_{0} ( \frac{ω}{2} - π ) \hat{x} ( \frac{ω}{2} ) ] \\ = \frac{1}{2} [ \begin{matrix}{e}^{- j m \frac{ω}{2}} {\hat{h}}_{1} ( - \frac{ω}{2} - π ) \hat{x} ( \frac{ω}{2} - π ) + \\ {e}^{- j m ( \frac{ω}{2} - π )} {\hat{h}}_{1} ( - \frac{ω}{2} ) \hat{x} ( \frac{ω}{2} )\end{matrix} ] \\ = \frac{{e}^{- j m \frac{ω}{2}}}{2} [ {\hat{h}}_{1}^{*} ( \frac{ω}{2} - π ) \hat{x} ( \frac{ω}{2} - π ) - {\hat{h}}_{1}^{*} ( \frac{ω}{2} ) \hat{x} ( \frac{ω}{2} ) ]$$

$${\hat{w}}_{1}^{{x}_{m}} ( ω ) = \frac{1}{2} [ {\hat{h}}_{1} ( \frac{ω}{2} ) \hat{x} ( \frac{ω}{2} - π ) + {\hat{h}}_{1} ( \frac{ω}{2} - π ) \hat{x} ( \frac{ω}{2} ) ] \\ = \frac{1}{2} [ \begin{matrix}- {e}^{- j m \frac{ω}{2}} {\hat{h}}_{0} ( - \frac{ω}{2} - π ) \hat{x} ( \frac{ω}{2} - π ) - \\ {e}^{- j m ( \frac{ω}{2} - π )} {\hat{h}}_{0} ( - \frac{ω}{2} ) \hat{x} ( \frac{ω}{2} )\end{matrix} ] \\ = \frac{{e}^{- j m \frac{ω}{2}}}{2} [ - {\hat{h}}_{0}^{*} ( \frac{ω}{2} - π ) \hat{x} ( \frac{ω}{2} - π ) + {\hat{h}}_{0}^{*} ( \frac{ω}{2} ) \hat{x} ( \frac{ω}{2} ) ] ,$$

where m is an odd integer, and * denotes the complex conjunction. A subtle but important detail of the equations above is that if the approximation and detail coefficients of x(n) were computed using h₀(−n−m) and h₁(−n−m) instead of h₀(n) and h₁(n), these coefficients behave exactly like the detail (w₁^{x}^{ₘ}(n)) and approximation (w₀^{x}^{ₘ}(n)) coefficients for (−1)ⁿx(n), respectively (note the reversed ordering of detail and approximation). It is straightforward to verify that if {h₀(n),h₁(n)} comprise perfect reconstruction filterbank, then {h₀(−n−m),h₁(−n−m)} constitute a legitimate perfect reconstruction filterbank as well (we will refer to the latter as the time-reversed filterbank). Reversal of coefficients is illustrated in FIG. 12—the system in 12(a) and 12(b) are equivalent. FIG. 12 illustrates examples of two equivalent filterbanks for xₘ(n)=(−1)ⁿx(n). Here, * indicates time-reversed filter coefficients.

Restricting our attention to the Haar decomposition for the rest of discussion and fixing m=1, we have that h₀(n)=h₀(−n−m) and h₁(n)=−h₁(−n−1) and the approximation coefficient of (−1)ⁿx(n) is exactly equal to the detail coefficient of x(n) by construction, and vice-versa—i.e. w₀^{x}^{ₘ}(n)=w₁^{x}(n) and w₁^{x}^{ₘ}(n)=w₀^{x}(n). It follows that the multi-level filterbank decomposition of (−1)ⁿx(n) is equivalent to the time-reversed filterbank decomposition of x(n), but with the reversed ordering of low-to-high frequency coefficients. This reversed-order filterbank can be used to derive the filterbank representation of xₛ(n). Specifically, let w₀^{x}^{ₛ}(n) and w₁^{x}^{ₛ}(n) be the approximation and detail coefficients of the one-level filterbank decomposition of xₛ(n). Then

$$\begin{matrix}{w}_{0}^{{x}_{s}} ( n ) = {w}_{0}^{1 / 2 ( x + {x}_{m} )} ( n ) \\ = \frac{1}{2} [ {w}_{0}^{x} ( n ) + {w}_{0}^{{x}_{m}} ( n ) ] \\ = \frac{1}{2} [ {w}_{0}^{x} ( n ) + {w}_{1}^{x} ( n ) ]\end{matrix}$$

$$\begin{matrix}{w}_{1}^{{x}_{s}} ( n ) = {w}_{1}^{1 / 2 ( x + {x}_{m} )} ( n ) \\ = \frac{1}{2} [ {w}_{1}^{x} ( n ) + {w}_{1}^{{x}_{m}} ( n ) ] \\ = \frac{1}{2} [ {w}_{1}^{x} ( n ) + {w}_{0}^{x} ( n ) ] \\ = {w}_{0}^{{x}_{s}} ( n ) .\end{matrix}$$

Now, update the definition of wᵢ^{x} to mean the i-th subband of (I+1)-level filterbank decomposition. Then by recursion, we have a general form

$${w}_{i}^{{x}_{s}} ( n ) = \frac{1}{2} [ {w}_{i}^{x} ( n ) + {w}_{I - i}^{x} ( n ) ] . \qquad ( VIII )$$

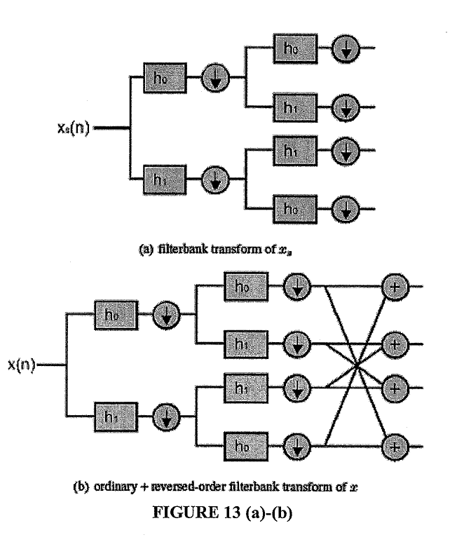

See FIG. 13. FIG. 13 illustrates examples of two equivalent filter banks for

$${x}_{s} = \frac{1}{2} ( x + {x}_{m} )$$

(up to multiplicative constant 2). In FIG. 13 used was the Haar decomposition. Similar analyses for xₛ can be performed for non-Haar decompositions, but are omitted here for simplicity.

Extending to two-dimensional signals, the decomposition of CFA image in the separable wavelet packet domain may be shown. Let wᵢ^{f}(n), wᵢ^{α}(n), wᵢ^{β}(n) be the filterbank coefficients corresponding to l(n), α(n), β(n), respectively, where i=(i₀, i₁)^{T}ε{0, 1, . . . , I}² indexes the horizontal and the vertical filterbank channels, respectively. As before, assume without loss of generality that c(0,0)=(1, 0, 0)^{T}. In order to apply the filterbank analysis to the sensor data, we re-write y(n) in the following manner:

$$\begin{matrix}y ( n ) = {x}_{2} ( n ) + {c}_{1} ( n ) α ( n ) + {c}_{3} ( n ) β ( n ) \\ = {x}_{2} ( n ) + [ 1 + {( - 1 )}^{{n}_{0}} + {( - 1 )}^{{n}_{1}} + {( - 1 )}^{n 0 + n 1} ] \frac{α ( n )}{4} + \\ [ 1 + {( - 1 )}^{{n}_{0} + 1} + {( - 1 )}^{{n}_{1} + 1} + {( - 1 )}^{n 0 + n 1} ] \frac{β ( n )}{4} ,\end{matrix}$$

and its corresponding filterbank representation:

$$\begin{matrix}{w}_{i}^{y} ( n ) = {w}_{i}^{{x}_{2}} ( n ) + \frac{1}{4} [ \begin{matrix}{w}_{i}^{α} ( n ) + {w}_{( {i}_{0} , I - {i}_{1} )}^{α} ( n ) + \\ {w}_{( I - {i}_{0} , {i}_{1} )}^{α} ( n ) + {w}_{( I - {i}_{0} , I - {i}_{1} )}^{α} ( n )\end{matrix} ] + \\ \frac{1}{4} [ \begin{matrix}{w}_{i}^{β} ( n ) - {w}_{( {i}_{0} , I - {i}_{1} )}^{β} ( n ) - \\ {w}_{( I - {i}_{0} , {i}_{1} )}^{β} ( n ) + {w}_{( I - {i}_{0} , I - {i}_{1} )}^{β} ( n )\end{matrix} ] \\ = {w}_{i}^{l} + \frac{1}{4} [ \begin{matrix}{w}_{( {i}_{0} , I - {i}_{1} )}^{α} ( n ) + \\ {w}_{( I - {i}_{0} , {i}_{1} )}^{α} ( n ) + {w}_{( I - {i}_{0} , I - {i}_{1} )}^{α} ( n )\end{matrix} ] \\ \frac{1}{4} [ \begin{matrix}- {w}_{( {i}_{0} , I - {i}_{1} )}^{β} ( n ) - \\ {w}_{( I - {i}_{0} , {i}_{1} )}^{β} ( n ) + {w}_{( I - {i}_{0} , I - {i}_{1} )}^{β} ( n )\end{matrix} ] ,\end{matrix}$$

where the minus signs in some w^{β} terms occur due to translation in space, and w^{f}(n) is the filterbank coefficients of the signal in(V). The globally bandlimitedness of difference images, discussed above allows us to conclude that wᵢ^{α}(n)≈0 and wᵢ^{β}(n)≈0, ∀i₀>Îori₁>Î for some Î. The above simplifies to a form that reveals the energy compaction structure within an example CFA image:

$${w}_{i}^{y} ( n ) \approx \{ \begin{matrix}{w}_{i}^{l} ( n ) + \frac{1}{4} [ \begin{matrix}{w}_{( I - {i}_{0} , {i}_{1} )}^{α} ( n ) - \\ {w}_{( I - {i}_{0} , {i}_{1} )}^{β} ( n )\end{matrix} ] & if I - {i}_{0} < \hat{I} and {i}_{1} < \hat{I} \\ {w}_{i}^{l} ( n ) + \frac{1}{4} [ \begin{matrix}{w}_{( {i}_{0} , I - {i}_{1} )}^{α} ( n ) - \\ {w}_{( {i}_{0} , I - {i}_{1} )}^{β} ( n )\end{matrix} ] & if {i}_{0} < \hat{I} and I - {i}_{1} < \hat{I} \\ {w}_{i}^{l} ( n ) + \frac{1}{4} [ \begin{matrix}{w}_{( I - {i}_{0} , I - {i}_{1} )}^{α} ( n ) + \\ {w}_{( I - {i}_{0} , I - {i}_{1} )}^{β} ( n )\end{matrix} ] & if I - {i}_{0} < \hat{I} and I - {i}_{1} < \hat{I} \\ {w}_{i}^{l} ( n ) & otherwise\end{matrix} \qquad ( IX )$$

Recall (II) and that the filterbank transforms with appropriate choices of filters constitutes a unitary transform. Thus,

$$\begin{matrix}{w}_{i}^{z} ( n ) = {w}_{i}^{y} ( n ) + {w}_{i}^{∈} ( n ) & ( X ) \\ \approx \{ \begin{matrix}{w}_{i}^{l} ( n ) + \frac{1}{4} [ \begin{matrix}{w}_{( I - {i}_{0} , {i}_{1} )}^{α} ( n ) - \\ {w}_{( I - {i}_{0} , {i}_{1} )}^{β} ( n )\end{matrix} ] + {w}_{i}^{∈} ( n ) & \begin{matrix}if I - {i}_{0} < \hat{I} \\ and {i}_{1} < \hat{I}\end{matrix} \\ {w}_{i}^{l} ( n ) + \frac{1}{4} [ \begin{matrix}{w}_{( {i}_{0} , I - {i}_{1} )}^{α} ( n ) - \\ {w}_{( {i}_{0} , I - {i}_{1} )}^{β} ( n )\end{matrix} ] + {w}_{i}^{∈} ( n ) & \begin{matrix}if {i}_{0} < \hat{I} \\ and I - {i}_{1} < \hat{I}\end{matrix} \\ {w}_{i}^{l} ( n ) + \frac{1}{4} [ \begin{matrix}{w}_{( I - {i}_{0} , I - {i}_{1} )}^{α} ( n ) + \\ {w}_{( I - {i}_{0} , I - {i}_{1} )}^{β} ( n )\end{matrix} ] + {w}_{i}^{∈} ( n ) & \begin{matrix}if I - {i}_{0} < \hat{I} \\ and I - {i}_{1} < \hat{I}\end{matrix} \\ {w}_{i}^{l} ( n ) + {ω}_{i}^{∈} ( n ) & otherwise ,\end{matrix} \\ where {w}_{i}^{∈} {∼}^{i . i . d .} 𝒩 ( 0 , {σ}_{∈}^{2} ) & ( XI )\end{matrix}$$

is a filterbank transform of ε(n). In other words, the filterbank transformation of noisy sensor data w^{z} is the baseband luminance coefficient w^{l} distorted by the noise w^{ε} and aliasing due to reversed-order filterbank coefficients w^{α} and w^{β}, where w^{l}, w^{α}, w^{β} are (conditionally) normal. Another example of a unified strategy to demosaicking and denoising, therefore, is to design an estimator that estimates w^{f}, w^{α}, and w^{β} from the mixture of w^{f}, w^{α}, w^{β}. and w^{ε}.

One should appreciate that (XI) can be generalized to any filterbanks that satisfy (VII) using time-reversed filter coefficients for h₀ and h₁.

In one embodiment, given that the difference images are sufficiently low-pass, simplification in (IX) reveal that there is a surprising degree of similarity between wᵢ^{y}(n) and wᵢ^{l}(n). Specifically, wᵢ^{y}(n)≈wᵢ^{l}(n) for the majority of subbands—the exceptions are the subbands that are normally considered high-frequency, which now contain a strong mixture of the low-frequency (or scaling) coefficients from the difference images, α and β. Operating under the premises that the filterbank transform decomposes image signals such that subbands are approximately uncorrelated from each other, the posterior mean estimate of wᵢ^{l}(n) takes the form

{wᵢ^{l}}^{est}(n)=E[wᵢ^{l}(n)|wᵢ^{z}]≈E[wᵢ^{l}(n)|wᵢ^{l+ε}]

for all subbands that meet the wᵢ^{y}(n)≈wᵢ^{l}(n) approximation. Wavelet shrinkage function ƒ: [symbol] → [symbol] , θ(wᵢ^{l+ε})=E(wᵢ^{l}(n)|wᵢ^{l+ε)} is leveraged to the CFA image context. In one example where wᵢ^{l}˜ [symbol] (0,σ_{l,i}²), the L² estimator is

$$f ( {w}_{i}^{z} ) = \frac{{σ}_{l , i}^{2}}{{σ}_{l , i}^{2} + {σ}_{∈}^{2}} {w}_{i}^{z} ( n ) .$$

However in embodiments wherein the subbands contain a mixture of wᵢ^{l}, wᵢ^{α}, wᵢ^{β}, and wᵢ^{ε}, require further analysis. In one example, let wᵢ^{α}(n)˜ [symbol] (0,σ_{α,i}²), wᵢ^{β}(n)˜ [symbol] (0,σ_{β,i}²). Consider the case such that i₀>I−Î and i₁<Î, and define j=(i₀,I−i₁), k=(I−i₀,I−i₁). Then wᵢ^{z}(n), wⱼ^{z}(n), wₖ^{z}(n) are highly correlated due to their common components in their mixture, w_{i′}^{α}, and w_{i′}^{β}, where i′=(I−i₀,i₁). Thus the L² estimates for wᵢ^{l}(n), wⱼ^{l}(n), wₖ^{l}(n) are

$$\begin{matrix}[ \begin{matrix}{\{ {w}_{i}^{l} \}}^{est} ( n ) \\ {\{ {w}_{j}^{l} \}}^{est} ( n ) \\ {\{ {w}_{k}^{l} \}}^{est} ( n ) \\ \end{matrix} ] = E ( [ \begin{matrix}{w}_{i}^{l} ( n ) \\ {w}_{j}^{l} ( n ) \\ {w}_{k}^{l} ( n )\end{matrix} ] \vert [ \begin{matrix}{w}_{i}^{z} ( n ) \\ {w}_{j}^{z} ( n ) \\ {w}_{k ( n )}^{z}\end{matrix} ] ) \\ = E ( {[ \begin{matrix}{w}_{i}^{l} ( n ) \\ {w}_{j}^{l} ( n ) \\ {w}_{k ( n )}^{l}\end{matrix} ] [ \begin{matrix}{w}_{i}^{z} ( n ) \\ {w}_{j}^{z} ( n ) \\ {w}_{k ( n )}^{z}\end{matrix} ]}^{T} ) {E ( {[ \begin{matrix}{w}_{i}^{z} ( n ) \\ {w}_{j}^{z} ( n ) \\ {w}_{k ( n )}^{z}\end{matrix} ] [ \begin{matrix}{w}_{i}^{z} ( n ) \\ {w}_{j}^{z} ( n ) \\ {w}_{k ( n )}^{z}\end{matrix} ]}^{T} )}^{- 1} [ \begin{matrix}{w}_{i}^{z} \\ {w}_{j}^{z} \\ {w}_{k}^{z}\end{matrix} ] \\ = [ \begin{matrix}{σ}_{l , i}^{2} & & \\ & {σ}_{l , j}^{2} & \\ & & {σ}_{l , k}^{2}\end{matrix} ] \\ {[ \begin{matrix}{σ}_{l , i}^{2} + {σ}_{ɛ}^{2} + \frac{{σ}_{α , {i}^{′}}^{2} + {σ}_{β , {i}^{′}}^{2}}{16} & \frac{{σ}_{α , {i}^{′}}^{2} - {σ}_{β , {i}^{′}}^{2}}{16} & \frac{{σ}_{α , {i}^{′}}^{2} + {σ}_{β , {i}^{′}}^{2}}{16} \\ \frac{{σ}_{α , {i}^{′}}^{2} - {σ}_{β , {i}^{′}}^{2}}{16} & {σ}_{l , j}^{2} + {σ}_{ɛ}^{2} + \frac{{σ}_{α , {i}^{′}}^{2} + {σ}_{β , {i}^{′}}^{2}}{16} & \frac{{σ}_{α , {i}^{′}}^{2} - {σ}_{β , {i}^{′}}^{2}}{16} \\ \frac{{σ}_{α , {i}^{′}}^{2} + {σ}_{β , {i}^{′}}^{2}}{16} & \frac{{σ}_{α , {i}^{′}}^{2} - {σ}_{β , {i}^{′}}^{2}}{16} & {σ}_{l , k}^{2} + {σ}_{ɛ}^{2} + \frac{{σ}_{α , {i}^{′}}^{2} + {σ}_{β , {i}^{′}}^{2}}{16}\end{matrix} ]}^{- 1} \\ [ \begin{matrix}{w}_{i}^{z} \\ {w}_{j}^{z} \\ {w}_{k}^{z}\end{matrix} ] .\end{matrix}$$

$$Similarly , \\ \begin{matrix}[ \begin{matrix}{\{ {w}_{{i}^{′}}^{α} \}}^{est} ( n ) \\ {\{ {w}_{{i}^{′}}^{β} \}}^{est} ( n )\end{matrix} ] = E ( [ \begin{matrix}{w}_{{i}^{′}}^{α} ( n ) \\ {w}_{{i}^{′}}^{β} ( n )\end{matrix} ] \vert [ \begin{matrix}{w}_{i}^{z} ( n ) \\ {w}_{j}^{z} ( n ) \\ {w}_{k ( n )}^{z}\end{matrix} ] ) \\ = E ( {[ \begin{matrix}{w}_{{i}^{′}}^{α} ( n ) \\ {w}_{{i}^{′}}^{β} ( n )\end{matrix} ] [ \begin{matrix}{w}_{i}^{z} ( n ) \\ {w}_{j}^{z} ( n ) \\ {w}_{k ( n )}^{z}\end{matrix} ]}^{T} ) {E ( {[ \begin{matrix}{w}_{i}^{z} ( n ) \\ {w}_{j}^{z} ( n ) \\ {w}_{k ( n )}^{z}\end{matrix} ] [ \begin{matrix}{w}_{i}^{z} ( n ) \\ {w}_{j}^{z} ( n ) \\ {w}_{k ( n )}^{z}\end{matrix} ]}^{T} )}^{- 1} [ \begin{matrix}{w}_{i}^{z} \\ {w}_{j}^{z} \\ {w}_{k}^{z}\end{matrix} ] \\ = [ \begin{matrix}\frac{{σ}_{α , {i}^{′}}^{2}}{16} & \frac{{σ}_{α , {i}^{′}}^{2}}{16} & \frac{{σ}_{α , {i}^{′}}^{2}}{16} \\ \frac{{σ}_{β , {i}^{′}}^{2}}{16} & \frac{{σ}_{β , {i}^{′}}^{2}}{16} & \frac{{σ}_{β , {i}^{′}}^{2}}{16} \end{matrix} ] \\ {[ \begin{matrix}{σ}_{l , i}^{2} + {σ}_{ɛ}^{2} + \frac{{σ}_{α , {i}^{′}}^{2} + {σ}_{β , {i}^{′}}^{2}}{16} & \frac{{σ}_{α , {i}^{′}}^{2} - {σ}_{β , {i}^{′}}^{2}}{16} & \frac{{σ}_{α , {i}^{′}}^{2} + {σ}_{β , {i}^{′}}^{2}}{16} \\ \frac{{σ}_{α , {i}^{′}}^{2} - {σ}_{β , {i}^{′}}^{2}}{16} & {σ}_{l , j}^{2} + {σ}_{ɛ}^{2} + \frac{{σ}_{α , {i}^{′}}^{2} + {σ}_{β , {i}^{′}}^{2}}{16} & \frac{{σ}_{α , {i}^{′}}^{2} - {σ}_{β , {i}^{′}}^{2}}{16} \\ \frac{{σ}_{α , {i}^{′}}^{2} + {σ}_{β , {i}^{′}}^{2}}{16} & \frac{{σ}_{α , {i}^{′}}^{2} - {σ}_{β , {i}^{′}}^{2}}{16} & {σ}_{l , k}^{2} + {σ}_{ɛ}^{2} + \frac{{σ}_{α , {i}^{′}}^{2} + {σ}_{β , {i}^{′}}^{2}}{16}\end{matrix} ]}^{- 1} \\ [ \begin{matrix}{w}_{i}^{z} \\ {w}_{j}^{z} \\ {w}_{k}^{z}\end{matrix} ] .\end{matrix}$$

Once {wᵢ^{l}}^{est}, {wᵢ^{α}}^{est}, {wᵢ^{β}}^{est} are computed ∀i,n as above, then x^{est}(n) is calculated by taking the inverse filterbank transform of {wᵢ^{l}}^{est}, {wᵢ^{α}}^{est}, {wᵢ^{β}}^{est} to find the estimates of l(n), α(n), β(n), which in turn is used to solve x^{est}.

Actual implementation of this method may include cycle-spinning, a technique in filterbank and wavelet processing whereby a linear space-variant system can be transformed into linear space-invariant system via averaging over all possible spacial shifts. One should appreciate that the estimator naturally extends to multivariate normal or heavy-tailed distributions.

According to one aspect, investigation of the relationship between the analysis and synthesis filters admits a closed-form expression for the filterbank coefficients corresponding to the subsampled signal in terms of the filterbank coefficients corresponding to the complete signal, where the subsequent reverse-ordered scale structure (ROSS) reveals the time-frequency analysis counterpart to the classical notion of aliasing and Nyquist rate in the Fourier domain. Examples of the ROSS in filterbank is highly versatile and particularly amenable to designing Bayesian statistical methods. A maximum likelihood estimator for model parameters and optimal l¹ and l² estimators for the complete signal given a noisy subsampled signal are derived, in some embodiments discussed below.

A celebrated result of Nyquist-Shannon sampling theorem states that exact reconstruction of a signal is possible if the signal is bandlimited and the sampling frequency is greater than twice the signal bandwidth. The Whittaker-Shannon ideal reconstruction, however, is an orthogonal projection of the observed data onto the span of all low-bandwidth signals, a task requiring a convolution with a sinc function with infinite support in time; and undersampling below the critical sampling rate (a.k.a Nyquist rate) results in a manifestation of aliasing, a phenomenon where the underlying signal is indistinguishable from the frequency-modulated version of the same signal. Witness the bid to approximate ideal reconstruction and to circumvent the critical sampling rate by exploiting additional information and structures known about the signal

Examples focus on a rigorous treatment of sampling when the underlying signal is inhomogeneous or nonstationary because the frequency domain perspective on sampling is inadequate to processing signals that do not exhibit low-pass qualities everywhere. The need to characterize inhomogeneous and locally stationary data have prompted the advancement of some joint time-frequency analysis techniques, including short-time Fourier transform, filterbanks, wavelets, and frames, and embodiments formalize the preeminent structure of aliasing governing them. Adopting the language of filterbanks and wavelets, shown is that a peculiar relationship between the analysis and synthesis filters admits a closed-form expression for the filterbank coefficients corresponding to the subsampled signal in terms of the filterbank coefficients corresponding to the complete signal. Some examples of these representations are useful for analyzing signal features that exhibit temporal locality, as they distinguish or isolate the regions susceptible to localized aliasing (to be made precise in the sequel) from regions that are unaffected by sampling. Note that this is a notion absent from the classical interpretation of aliasing in the Fourier sense, as it is defined globally.

In some embodiments, the form of time-frequency analysis proposed subsequently gives rise to a reverse-ordered scale structure (ROSS), a fundamental structure to localized aliasing. The ROSS, in conjunction with the vanishing moment property of wavelet transforms, suggests a Nyquist rate “counterpart” in terms of smoothness of the underlying functions that can be re-cast as a condition for exact reconstructability when sampling inhomogeneous signals.

Alternatively, the closed-form expression for the subsampled signals in the transform domain and the ROSS warrant a direct manipulation of the filterbank coefficients. While the transform coefficients corresponding to the complete signal are not observed, in one example, explicitly, the coefficients of the subsampled signals are nevertheless not far removed from the desiderata. Adopting a Bayesian statistics point of view in one embodiment; that is, model the complete signal in terms of the prior probability for the transform coefficients, and the loss of information due to subsampling is coded into the likelihood function. Then the posterior distribution of the coefficients are readily accessible by reversing the arguments for ROSS, and minimization of Bayes risk is an attainable goal in some embodiments, without invoking the statistical treatment of missing data, a mathematically cumbersome and computationally demanding task. A maximum likelihood estimator of the model parameters and the optimal l¹ and l² estimators for complete signal given a noisy subsampled signal are derived below, for some embodiments.

Filterbank, which superceeds discrete wavelet transform, is a convenient form of analyzing inhomogeneous and nonstationary discrete signals. Local in both frequency and time, filterbank coefficients represent the concentration of energy in nearby frequency components and in nearby samples. Let x: [symbol] → [symbol] be a one-dimensional signal, and nε [symbol] an integer index. Then we define subsampled signal xₛ: [symbol] → [symbol] as

$${x}_{s} ( n ) = \frac{1}{2} [ x ( n ) + {( - 1 )}^{n} x ( n ) ] = \{ \begin{matrix}x ( n ) & if n even \\ 0 & if n odd .\end{matrix} \\ Equivalently , \\ {\hat{x}}_{s} ( ω ) = \frac{1}{2} [ \hat{x} ( ω ) + \hat{x} ( ω - π ) ] , \qquad ( R 1 )$$

where [symbol] × [symbol] → [symbol] /2π× [symbol] is the discrete Fourier transform operator and ωε [symbol] /2π its corresponding normalized frequency. An observation here is that the subsampled signal xₛ(n), for some embodiments is an arithmetic average of the signal of interest x(n) and its frequency modulated version (−1)ⁿx(n). When the bandwidth of the signal (i.e. the support of the signal in the Fourier domain) is sufficiently large, \hat{x}(ω) and \hat{x}(ω−π) are indistinguishable in \hat{x}ₛ(ω), and this phenomenon is called aliasing—the classical interpretation is that the aliased portions of the signal are irrecoverable from \hat{x}ₛ(ω).

Let g₀, g₁, h₀, h₁: [symbol] → [symbol] be finite impulse response filters and iε{0,1}. Formally, vᵢ^{x}(n) is a one-level filterbank coefficient corresponding to the signal x: [symbol] → [symbol] if

vᵢ^{x}(n)={gᵢ [symbol] x}(2n), (R2)

where [symbol] denotes a convolution operator; or correspondingly,

$${\hat{v}}_{i}^{x} ( ω ) = \frac{1}{2} [ {\hat{g}}_{i} ( \frac{ω}{2} ) \hat{x} ( \frac{ω}{2} ) + {\hat{g}}_{i} ( \frac{ω}{2} - π ) \hat{x} ( \frac{ω}{2} - π ) ] .$$

The set, {vᵢ^{x}(n):∀nε [symbol] }, is collectively referred to as the ith filterbank channel. In one example, Filterbank transform is said to be perfectly reconstructable if xᵣ=x, where

\hat{x}ᵣ(ω)=ĥ₀(ω)\hat{v}₀^{x}(2ω)+ĥ₁(ω)\hat{v}₁^{x}(2ω), (R3)

or equivalently using standard polyphase notation,

xᵣ(2n)={[h₀(2m)] [symbol] [v₀^{x}(m)]}(n)+{[h₁(2m)] [symbol] [v₁^{x}(m)]}(n)

xᵣ(2n+1)={[h₀(2m+1)] [symbol] [v₀^{x}(m)]}(n)+{[h₁(2m+1)] [symbol] [v₁^{x}(m)]}(n),

where the summation in the convolution [symbol] is performed over the index m. The reconstruction step in (R3) is commonly referred to as the synthesis filterbank.

In one example, let j=\sqrt{−1}. Important and well-known theorems associated with (R2) and (R3) have established the following.

Theorem 1 (Vetterli) The filterbank {g₀, g₁, h₀, h₁} is perfectly reconstructable for any input signal if and only if the following statements are true:

ĝ₀(ω)ĥ₀(ω)+ĝ₁(ω)ĥ₁(ω)=2

ĝ₀(ω)ĥ₀(ω−π)+ĝ₁(ω)ĥ₁(ω−π)=0

Theorem 2 (Mallat) If the filterbank {g₀, g₁, h₀, h₁} is perfectly reconstructable, then

ĝ₀(ω)ĥ₀(ω)+ĝ₀(ω−π)ĥ₀(ω−π)=2

and

ĝ₁(ω)=ae^{j(2b+1)ω}ĥ₀(ω−π)

ĥ₁(ω)=a⁻¹e^{-j(2b+1)ω}ĝ₀(ω−π)

for some aε [symbol] and bε [symbol] .

The above theorems are the basis for the reverse-ordered scale structure in filterbanks, in some embodiments. Also, define \tilde{g}ᵢ(n)=a⁻¹gᵢ(n+(2b+1)) and \tilde{h}ᵢ(n)=ahᵢ(n−(2b+1)) (time-reversed, time-shifted, and scaled versions of gᵢ and hᵢ), where a and b are as defined in Theorem 2. Then wᵢ^{x}(n) is called a dual-filterbank coefficient of vᵢ^{x}(n) if

wᵢ^{x}(n)={\tilde{h}ᵢ [symbol] x}(2n)

Straightforward brute-force arithmetics verify that if the filterbank {g₀, g₁, h₀, h₁} is perfectly reconstructable, then the filterbank { g̅₀, g̅₁, h̅₀, h̅₁} is perfectly reconstructable as well. That is, x_{r′}=x, where

$${\hat{x}}_{{r}^{′}} ( ω ) = {\hat{\tilde{g}}}_{0} ( ω ) {\hat{w}}_{0}^{x} ( 2 ω ) + {\hat{\tilde{g}}}_{1} ( ω ) {\hat{w}}_{1}^{x} ( 2 ω ) .$$

In general, if g₀ is a low-pass filter, h₀ is a low-pass and g₁ and h₁ are high-pass. Thus, v₀^{x} and w₀^{x} measure local low-pass energy concentration while v₁^{x} and w₁^{x} measure local high-pass energy. The time-frequency resolution can be fine-tuned by nesting the one-level transform recursively.

Provable Examples of Reverse-Ordered Scale Structure and Subsampled Signal

Lemma 3 (Reverse-Order) Define modulated signal xₘ=(−1)″x(n). If the filterbank {g₀, g₁, h₀, h₁} is perfectly reconstructable, then

vᵢ^{x}^{ₘ}(n)=(−1)ⁱw₁₋ᵢ^{x}(n). (R4)

Proof. Assume that the filterbank {g₀, g₁, h₀, h₁} is perfectly reconstructable. Modulation of \hat{x} by π implies

$$\begin{matrix}{\hat{v}}_{i}^{{x}_{m}} ( ω ) = \frac{1}{2} [ {\hat{g}}_{i} ( \frac{ω}{2} ) {\hat{x}}_{m} ( \frac{ω}{2} ) + {\hat{g}}_{i} ( \frac{ω}{2} - π ) {\hat{x}}_{m} ( \frac{ω}{2} - π ) ] \\ = \frac{1}{2} [ {\hat{g}}_{i} ( \frac{ω}{2} ) \hat{x} ( \frac{ω}{2} - π ) + {\hat{g}}_{i} ( \frac{ω}{2} - π ) \hat{x} ( \frac{ω}{2} ) ]\end{matrix} \\ By Theorem 2 , \\ \begin{matrix}{\hat{g}}_{i} ( ω ) = {( - 1 )}^{1 - i} a {e}^{j ( 2 b + 1 ) ω} {\hat{h}}_{1 - i} ( ω - π ) \\ = {( - 1 )}^{i} a {e}^{j ( 2 b + 1 ) ( ω - π )} {\hat{h}}_{1 - i} ( ω - π ) \\ = {( - 1 )}^{i} {\hat{\tilde{h}}}_{1 - i} ( ω - π ) ,\end{matrix} \qquad ( R 5 )$$

where we used the property [symbol] (ω)=ae^{j(2b+1)ω}ĥᵢ(ω). Substituting (R5) for gᵢ yields

$$\begin{matrix}{\hat{v}}_{i}^{{x}_{m}} ( ω ) = \frac{{( - 1 )}^{i}}{2} [ {\hat{\tilde{h}}}_{1 - i} ( \frac{ω}{2} ) \hat{x} ( \frac{ω}{2} ) + {\hat{\tilde{h}}}_{1 - i} ( \frac{ω}{2} - π ) \hat{x} ( \frac{ω}{2} - π ) ] \\ = {( - 1 )}^{i} {\hat{w}}_{1 - i}^{x} ( ω ) .\end{matrix}$$

Corollary 4 (Modulation) The filterbank {g₀, g₁, h₀, h₁} is perfectly reconstructable. Then

$${\hat{h}}_{0} ( ω ) {\hat{\tilde{h}}}_{1} ( ω - π ) - {\hat{h}}_{1} ( ω ) {\hat{\tilde{h}}}_{0} ( ω - π ) = 2$$

$${\hat{h}}_{0} ( ω ) {\hat{\tilde{h}}}_{1} ( ω ) - {\hat{h}}_{1} ( ω ) {\hat{\tilde{h}}}_{0} ( ω ) = 0$$

Proof Substituting (R5) into Theorem 1,

$$\begin{matrix}2 = {\hat{h}}_{0} ( ω ) {\hat{g}}_{0} ( ω ) + {\hat{h}}_{1} ( ω ) {\hat{g}}_{1} ( ω ) \\ = {\hat{h}}_{0} ( ω ) {\hat{\tilde{h}}}_{1} ( ω - π ) - {\hat{h}}_{1} ( ω ) {\hat{\tilde{h}}}_{0} ( ω - π )\end{matrix}$$

$$\begin{matrix}0 = {\hat{h}}_{0} ( ω - π ) {\hat{g}}_{0} ( ω ) + {\hat{h}}_{1} ( ω - π ) {\hat{g}}_{1} ( ω ) \\ = {\hat{h}}_{0} ( ω - π ) {\hat{\tilde{h}}}_{1} ( ω - π ) - {\hat{h}}_{1} ( ω - π ) {\hat{\tilde{h}}}_{0} ( ω - π ) \\ = {\hat{h}}_{0} ( ω ) {\hat{\tilde{h}}}_{1} ( ω ) - {\hat{h}}_{1} ( ω ) {\hat{\tilde{h}}}_{0} ( ω ) ,\end{matrix}$$

where the last equality comes from plugging in ω for ω−π.

Lemma 5 (Localized Aliasing) Define subsampled signal xₛ(n) as before. If the filterbank {g₀, g₁, h₀, h₁} is perfectly reconstructable, then

$${v}_{i}^{{x}_{s}} ( n ) = {( - 1 )}^{i} {w}_{1 - i}^{{x}_{s}} ( n ) = \frac{1}{2} [ {v}_{i}^{x} ( n ) + {( - 1 )}^{i} {w}_{1 - i}^{x} ( n ) ] . \\ Proof . From ( R 1 ) , \\ \begin{matrix}{v}_{i}^{{x}_{s}} ( n ) = {v}_{i}^{1 / 2 [ x + {x}_{m} ]} ( n ) \\ = \frac{1}{2} [ {v}_{i}^{x} ( n ) + {v}_{i}^{{x}_{m}} ( n ) ] \\ = \frac{1}{2} [ {v}_{i}^{x} ( n ) + ( - {1}^{i} ) {w}_{1 - i}^{x} ( n ) ]\end{matrix}$$

where the last equality comes from Lemma 3. Furthermore, solving for w₁₋ᵢ^{x}^{ₘ}(n) in (R4),

$${( - 1 )}^{i} {w}_{1 - i}^{x} ( n ) = {v}_{i}^{{x}_{m}} ( n )$$

$${( - 1 )}^{i} {w}_{1 - i}^{{x}_{m}} ( n ) = {v}_{i}^{x} ( n )$$

$${w}_{1 - i}^{{x}_{m}} ( n ) = {( - 1 )}^{i} {v}_{i}^{x} ( n ) . \\ Then , \\ \begin{matrix}{( - 1 )}^{i} {w}_{1 - i}^{{x}_{s}} ( n ) = {( - 1 )}^{i} {w}_{1 - i}^{1 / 2 [ x + {x}_{m} ]} ( n ) \\ = \frac{{( - 1 )}^{i}}{2} [ {w}_{1 - i}^{x} ( n ) + {w}_{1 - i}^{{x}_{m}} ( n ) ] \\ = \frac{{( - 1 )}^{i}}{2} [ {w}_{1 - i}^{x} ( n ) + {( - 1 )}^{i} {v}_{i}^{x} ( n ) ] \\ = \frac{1}{2} [ {( - 1 )}^{i} {w}_{1 - i}^{x} ( n ) + {v}_{i}^{x} ( n ) ] \\ = {v}_{i}^{{x}_{s}} ( n ) .\end{matrix}$$

Lemma 3 characterizes the reversal of scale ordering when the signal x(n) is modulated by π. That is, the low-frequency filterbank coefficient for the modulated signal (v₀^{x}^{ₘ}(n)) behaves like the high-frequency dual filterbank coefficient for the original signal (w₁^{x}(n)), and vice-versa. This filterbank channel role-reversal is consistent with the Fourier interpretation of modulation by π, as the low- and high-frequency components are swapped, per modulo-2π.

Corollary 4 offers another interpretation for the ROSS in filterbank: exchanging the low- and high-frequency channels of the synthesis filterbank results in modulation. To see this, consider reconstruction of the dual-filterbank coefficients via the synthesis filterbank (R3) with reverse-ordered channels:

$$\begin{matrix}{\hat{x}}_{r} ( ω ) = {\hat{h}}_{0} ( ω ) {\hat{w}}_{1}^{x} ( 2 ω ) - {\hat{h}}_{1} ( ω ) {\hat{w}}_{0}^{x} ( 2 ω ) \\ = \frac{1}{2} {\hat{h}}_{0} ( ω ) [ {\hat{\tilde{h}}}_{1} ( ω ) \hat{x} ( ω ) + {\hat{\tilde{h}}}_{1} ( ω - π ) \hat{x} ( ω - π ) ] - \\ \frac{1}{2} {\hat{h}}_{1} ( ω ) [ {\hat{\tilde{h}}}_{0} ( ω ) \hat{x} ( ω ) + {\hat{\tilde{h}}}_{0} ( ω - π ) \hat{x} ( ω - π ) ] \\ = \frac{1}{2} \hat{x} ( ω ) [ {\hat{h}}_{0} ( ω ) {\hat{\tilde{h}}}_{1} ( ω ) - {\hat{h}}_{1} ( ω ) {\hat{\tilde{h}}}_{0} ( ω ) ] + \\ \frac{1}{2} \hat{x} ( ω - π ) [ {\hat{h}}_{0} ( ω ) {\hat{\tilde{h}}}_{1} ( ω - π ) - {\hat{h}}_{1} ( ω ) {\hat{\tilde{h}}}_{0} ( ω - π ) ] \\ = \frac{1}{2} \hat{x} ( ω ) \cdot 0 + \frac{1}{2} \hat{x} ( ω - π ) \cdot 2 \\ = \hat{x} ( ω - π ) .\end{matrix}$$

Similarly, Lemma 5 is the joint time-frequency analysis counterpart to the aliasing in (R1). Filterbank coefficients corresponding to the subsampled signal xₛ(n) are arithmetic averages of low- and high-frequency coefficients corresponding to x(n), and localized aliasing occurs when vᵢ^{x}(n) and w₁₋ᵢ^{x}^{ₘ}(n) are both supported simultaneously and hence indistinguishable in vᵢ^{x}^{ₛ}(n). Unlike (R1), however, the aliasing is confined to a temporally localized region when the underlying sequence is inhomogeneous, as vᵢ^{x}(n) and w₁₋ᵢ^{x}^{ₘ}(n) are indexed by the location pointer n.

If in some embodiments, we restrict our attention to orthogonal or Smith-Barnwell type filterbanks, we have

ĝ₁(ω)=·e^{j(2b+1)ω}ĝ₀^{e}(ω−π),

where ‘*’ denotes complex conjunction. Solving for ĝ₀(ω) gives

ĝ₀(ω)=e^{j(2b+1)ω}ĝ₁*(ω−π)

and by Theorem 2,

$$\begin{matrix}{\hat{h}}_{0} ( ω ) = - {a}^{- 1} {e}^{- j ( 2 b + 1 ) ω} {\hat{g}}_{1} ( ω - π ) \\ = - {a}^{- 1} {e}^{- j ( 2 b + 1 ) ω} ( - {e}^{j ( 2 b + 1 ) ( ω - π )} {\hat{g}}_{0}^{*} ( ω ) ) \\ = - {a}^{- 1} {\hat{g}}_{0}^{*} ( ω )\end{matrix}$$

$$\begin{matrix}{\hat{h}}_{1} ( ω ) = - {a}^{- 1} {e}^{- j ( 2 b + 1 ) ω} {\hat{g}}_{0} ( ω - π ) \\ = - {a}^{- 1} {e}^{- j ( 2 b + 1 ) ω} ( {e}^{j ( 2 b + 1 ) ( ω - π )} {\hat{g}}_{1}^{*} ( ω ) ) \\ = - {a}^{- 1} {\hat{g}}_{1}^{*} ( ω ) .\end{matrix}$$

In one particular example, Haar wavelets have the special property that ĝᵢ(ω)=(−1)ⁱe^{j(2b+1)ω}ĝᵢ*(ω), and its ROSS reduces to a remarkably simple form:

$${v}_{i}^{{x}_{m}} ( n ) = {v}_{1 - i}^{x} ( n ) . \\ To see this , \\ \begin{matrix}{\hat{\tilde{h}}}_{i} ( ω ) = a {e}^{j ( 2 b + 1 ) ω} {\hat{h}}_{i} ( ω ) \\ = a {e}^{j ( 2 b + 1 ) ω} ( - {a}^{- 1} {\hat{g}}_{i}^{*} ( ω ) ) \\ = - {e}^{j ( 2 b + 1 ) ω} {\hat{g}}_{i}^{*} ( ω ) \\ = {( - 1 )}^{1 - i} {\hat{g}}_{i} ( ω ) .\end{matrix}$$

$$From Lemma 3 , \\ \begin{matrix}{v}_{i}^{{x}_{m}} ( n ) = {( - 1 )}^{i} {w}_{1 - i}^{x} ( n ) \\ = {( - 1 )}^{i} \{ {\tilde{h}}_{1 - i} ⊗ x \} ( 2 n ) \\ = {( - 1 )}^{i} \{ {( - 1 )}^{i} {g}_{1 - i} ⊗ x \} ( 2 n ) \\ = \{ {g}_{1 - i} ⊗ x \} ( 2 n ) \\ = {v}_{1 - i}^{x} ( n ) .\end{matrix}$$

$$\begin{matrix}{v}_{i}^{{x}_{s}} ( n ) = \frac{1}{2} [ {v}_{i}^{x} ( n ) + {v}_{i}^{{x}_{m}} ( n ) ] \\ = \frac{1}{2} [ {v}_{i}^{x} ( n ) + {v}_{1 - i}^{x} ( n ) ]\end{matrix}$$

It follows that

### Multilevel Expansion Example

According to one aspect, multilevel filterbank expansion, or wavelet packets, is a means to gain more precision in frequency at the cost of resolution in time. Modify the definition of vᵢ^{x}(n) to be the I-level filterbank coefficient corresponding to the signal x, where i=(i₀, i₁, . . . , i₁)^{T} and iₖε{0,1} indexes the analysis filters used in the kth level decomposition (i.e. g₀ or g₁). More precisely, we recursively apply (R2) to x repeatedly as follows:

v₁^{x}(n)={gᵢ_{_{I}} [symbol] { . . . {gᵢ_{₁}(m₁) [symbol] {gᵢ_{₀} [symbol] x}(2m₁)}(2m₂) . . . }(2m_{I})}(2n). (R6)

Acknowledging an abuse of notation, update the definition of wᵢ^{x}(n) also as follows:

wᵢ^{x}(n)={gᵢ_{_{I}} [symbol] { . . . {gᵢ_{₁}(m₁) [symbol] {\tilde{h}ᵢ_{₀} [symbol] x}(2m₁)}(2m₂) . . . }(2m_{I})}(2n). (R7)

Note that the dual basis, { h̅₀, h̅₁}, is used in the 0th level decomposition only. Then the ROSS naturally generalizes to multilevel filterbank, as outlined in the corollary to Lemmas 3 and 5 below.

Corollary 6 (Multilevel ROSS) Suppose the filterbank {g₀, gₗ, h₀, h₁} is perfectly reconstructable. Let i=(i₀, i₁, . . . , i_{I})^{T} and iₖε{0,1} as before, and define i′=(1−i₀, i₁, . . . , i_{I})^{T}. Then the following two statements are true:

$${v}_{i}^{{x}_{m}} = {( - 1 )}^{{i}_{0}} {w}_{{i}^{′}}^{x} ( n )$$

$$\begin{matrix}{v}_{i}^{{x}_{s}} = {( - 1 )}^{{i}_{0}} {w}_{{i}^{′}}^{{x}_{s}} ( n ) \\ = \frac{1}{2} [ {v}_{i}^{x} ( n ) + {( - 1 )}^{{i}_{0}} {w}_{{i}^{′}}^{x} ( n ) ]\end{matrix}$$

Proof. The proof is a straightforward application of Lemmas 3 and 5. Substituting Lemma 3 into (R6),

$$\begin{matrix}{v}_{i}^{x} ( n ) = \{ {g}_{{i}_{I}} {⊗}_{{m}_{I}} \{ … \{ \begin{matrix}{g}_{{i}_{1}} ( {m}_{1} ) {⊗}_{{m}_{1}} \\ \{ {g}_{{i}_{0}} ⊗ {x}_{m} \} ( 2 {m}_{1} )\end{matrix} \} ( 2 {m}_{2} ) … \} ( 2 {m}_{I} ) \} ( 2 n ) \\ = \{ \begin{matrix}{g}_{{i}_{I}} {⊗}_{{m}_{I}} \\ \{ … \{ \begin{matrix}{g}_{{i}_{1}} ( {m}_{1} ) {⊗}_{{m}_{1}} \\ \{ {( - 1 )}^{{i}_{0}} {\tilde{h}}_{1 - {i}_{0}} ⊗ x \} ( 2 {m}_{1} )\end{matrix} \} ( 2 {m}_{2} ) … \} ( 2 {m}_{I} )\end{matrix} \} ( 2 n ) \\ = {( - 1 )}^{{i}_{0}} {w}_{{i}^{′}}^{x} ( n )\end{matrix}$$

$$\begin{matrix}{v}_{i}^{{x}_{s}} ( n ) = \frac{1}{2} [ {v}_{i}^{x} ( n ) + {v}_{i}^{{x}_{m}} ( n ) ] \\ = \frac{1}{2} [ {v}_{i}^{x} ( n ) + {( - 1 )}^{{i}_{0}} {w}_{{i}^{′}}^{x} ( n ) ] .\end{matrix}$$

The sketch of the proof for vᵢ^{x}^{ₛ}=(−1)ⁱ^{₀}w_{i′}^{x}^{ₛ}(n) follows the exact scenario in the proof of Lemma 5.

Connections to Continuous Time Signals

This form of time-frequency analysis reveals the fundamental structure to aliasing, in some embodiments.

According to another aspect, given a subsampled signal (or observation), suppose we are interested in estimating or making a statistical inference on the complete signal (or latent variable). Bayesian statistical estimation and inference techniques make use of the posterior probability, or the probability of a latent variable conditioned on the observation. It is proportional to the product of the prior, or prior probability distribution of the latent variable, and the likelihood function, or the probability of the observation conditioned on the latent variable.

Owing to the properties of joint time-frequency analysis that compress energy and approximately decorrelate temporal redundancies in sequential data, filterbank and wavelets are popular and convenient platforms for statistical signal modeling, applications of which include real-world signals in speech, audio, and images. Issues pertaining to the loss of information due to subsampling is difficult to reconcile because the effects of each lost sample permeate across scale and through multiple coefficients.

The loss of information due to subsampling, as characterized by the ROSS, can be coded into the likelihood function of the observed filterbank coefficients, in some embodiments. Consequently, the posterior distribution of the filterbank coefficients vᵢ^{x}(n) is readily accessible as the prior and likelihood are now both prescribed in the filterbank domain. Detailing the likelihood function as deduced from Lemma 5, and assuming a conditionally normal prior distribution (which is by now a standard practice), derive the corresponding posterior distribution and optimal l¹ and l² estimators for the latent variables, and an algorithm to estimate the model parameters that maximize the marginal log-likelihood of the observation in some embodiments.

Some embodiments assume that the filterbank coefficients are independent, and use the fact that vᵢ^{x}(n) and w_{i′}^{x}(n) are independent.

Likelihood Function, Posterior Distribution, and Time-Frequency Analysis

Lemma 5 linearly combines a filterbank coefficient with its reverse-ordered dual coefficient as a result of subsampling. Thus, the likelihood of an observed filterbank coefficient simplifies to:

p(vᵢ^{x}^{ₛ}(n)|x)=p(vᵢ^{x}^{ₛ}(n)|vᵢ^{x}(n),w_{i′}^{x}(n)). (R8)

In one embodiment, let i′=(1−i₀, i₁, . . . , i_{I})^{T} as before, and where understood, we hereafter drop the time index n and the superscript x from vᵢ^{x}(n), (n). Then, the joint posterior distribution of vᵢ^{x}(n) and w_{i′}^{x}(n) is

$$\begin{matrix}p ( {v}_{i} , {w}_{{i}^{′}} \vert {x}_{s} ) = \frac{p ( {x}_{s} \vert {v}_{i} , {w}_{{i}^{′}} ) p ( {v}_{i} , {w}_{{i}^{′}} )}{p ( {x}_{s} )} \\ = \frac{p ( {v}_{i}^{{x}_{s}} \vert {v}_{i} , {w}_{{i}^{′}} ) p ( {v}_{i} , {w}_{{i}^{′}} )}{p ( {v}_{i}^{{x}_{s}} )} \\ = δ ( {v}_{i}^{{x}_{s}} - \frac{1}{2} [ {v}_{i} + {( - 1 )}^{{i}_{0}} {w}_{{i}^{′}} ] ) \frac{p ( {v}_{i} , {w}_{{i}^{′}} )}{p ( {v}_{i}^{{x}_{s}} )} ,\end{matrix}$$

where δ(•) is a Dirac function. Suppose the observation y(n) is made in noise,

$$y ( n ) \vert {x}_{s} ( n ) {∼}^{i . i . d .} 𝒩 ( {x}_{s} ( n ) , {σ}^{2} ) . \qquad ( R9 )$$

and when let {g₀, g₁, h₀, h₁} comprise an orthonormal filterbank,

$${v}_{i}^{y} ( n ) \vert {v}_{i}^{{x}_{s}} ( n ) {∼}^{i . i . d .} 𝒩 ( {v}_{i}^{{x}_{s}} ( n ) , {σ}^{2} ) .$$

Then the joint posterior distribution of vᵢ^{x}(n) and w_{i′}^{x}(n) is

$$\begin{matrix}p ( {v}_{i} , {w}_{{i}^{′}} \vert y ) = φ ( {v}_{i}^{y} - \frac{1}{2} [ {v}_{i} + {( - 1 )}^{{i}_{0}} {w}_{{i}^{′}} ] \vert {σ}_{2} ) \frac{p ( {v}_{i} , {w}_{{i}^{′}} )}{p ( {v}_{i}^{y} )} \\ = 2 φ ( 2 {v}_{i}^{y} - [ {v}_{i} + {( - 1 )}^{{i}_{0}} {w}_{{i}^{′}} ] \vert 4 {σ}_{2} ) \frac{p ( {v}_{i} ) p ( {w}_{{i}^{′}} )}{p ( {v}_{i}^{y} )} ,\end{matrix}$$

$$where$$

$$φ ( x \vert {σ}^{2} ) = {( 2 π {σ}^{2} )}^{- \frac{1}{2}} {e}^{- \frac{{x}^{2}}{2 {σ}^{2}}}$$

kφ(kx|(kσ)²)=φ(x|σ²). Integration over all possible values of w_{i′}^{x}(n) yields

$$\begin{matrix}p ( {v}_{i} \vert y ) = 2 \int φ ( 2 {v}_{i}^{y} - [ {v}_{i} + {( - 1 )}^{{i}_{0}} {w}_{{i}^{′}} ] \vert 4 {σ}^{2} ) \frac{p ( {v}_{i} ) p ( {w}_{{i}^{′}} )}{p ( {v}_{i}^{y} )} d {w}_{{i}^{′}} \\ = 2 \frac{p ( {v}_{i} )}{p ( {v}_{i}^{y} )} \{ φ ( {w}_{{i}^{′}} \vert 4 {σ}^{2} ) {⊗}_{{w}_{{i}^{′}}} p ( {( - 1 )}^{{i}_{0}} {w}_{{i}^{′}} ) \} ( 2 {v}_{i}^{y} - {v}_{i} ) ,\end{matrix} \qquad ( R10 )$$

where we used the definition of convolution in the last step. Another interpretation is that we have a standard form of posterior distribution in (R10):

$$p ( {v}_{i} \vert y ) = \frac{p ( {v}_{i}^{y} \vert {v}_{i} ) p ( {v}_{i} )}{p ( {v}_{i}^{y} )} ,$$

where the likelihood of (n) with respect to vᵢ^{y}(n) is

p(vᵢ^{y}|vᵢ)=2{φ(w_{i′}|4σ²) [symbol] p((−1)ⁱ^{₀}w_{i′})}(2vᵢ^{y}−vᵢ),

which could have been derived from (R8) directly by integrating out the dependencies on wᵢ^{x}:

$$\begin{matrix}p ( {v}_{i}^{y} \vert {v}_{i} ) = \int p ( {v}_{i}^{y} \vert {v}_{i} , {w}_{{i}^{′}} ) p ( {w}_{{i}^{′}} \vert {v}_{i} ) d {w}_{{i}^{′}} \\ = 2 \int φ ( 2 {v}_{i}^{y} - [ {v}_{i} + {( - 1 )}^{{i}_{0}} {w}_{{i}^{′}} ] \vert 4 {σ}^{2} ) p ( {w}_{{i}^{′}} \vert {v}_{i} ) d {w}_{{i}^{′}} .\end{matrix}$$

As an alternative to the noise model in (R9), it is probable that noisy measurements may have been made for even-indexed samples only (i.e. 2n):

$${y}_{s} ( 2 n ) \vert {x}_{s} ( 2 n ) {∼}^{i . i . d .} 𝒩 ( {x}_{s} ( 2 n ) , {σ}^{2} )$$

$${y}_{s} ( 2 n + 1 ) \vert {x}_{s} ( 2 n + 1 ) {∼}^{i . i . d .} 𝒩 ( {x}_{s} ( 2 n + 1 ) , 0 ) = 𝒩 ( 0 , 0 ) .$$

Conceptually, yₛ(n) is equivalent to making a noisy measurement on the complete signal x(n) first before subsampling according to the model in (R1). Thus vᵢ^{y}^{ₛ}(n) obeys Corollary 6 (and Lemma 5), where if we continue to assume for some embodiments, {g₀, g₁, h₀, h₁} comprise an orthonormal filterbank, the averaging in Corollary 6 occurs between vᵢ^{x} and w_{i′}^{x} that are both corrupted by i.i.d. noise with distribution [symbol] (0,σ²). Effectively, vᵢ^{y}^{ₛ}(n)|vᵢ^{x}^{ₛ}(n)˜ [symbol] (vᵢ^{x}^{ₛ}(n),σ²/2), and the posterior distribution in (R10) and all other results presented are equally valid for yₛ if we replace σ² with σ²/2. According to one embodiment, it is realized that the noise in IP would no longer be independent, as noise in vᵢ^{y}^{ₛ} and w_{i′}^{y}^{ₛ} are perfectly correlated (and correlated with v_{i′}^{y}^{ₛ} by extension).

Heavy-Tailed Prior Distribution

Adopting Bayesian statistical methods for some embodiments, coefficients modeled with conditionally normal distributions have conditionally normal posterior distribution as well. the following form appears frequently:

$${v}_{i}^{x} ( n ) {∼}^{i . i . d .} N ( 0 , {ρ}_{i}^{2} / {q}_{i} ( n ) ) ,$$

where ρᵢ² is the variance of vᵢ^{x} in the i-channel, and qᵢ(n)≠0 is also a random variable whose distribution is as specified by sparsity and the shape of the tail. Similarly, let

$${w}_{i}^{x} ( n ) {∼}^{i . i . d .} N ( 0 , {λ}_{i}^{2} / {r}_{i} ( n ) ) ,$$

where rᵢ(n)≠0 is a random variable whose distribution we expect is identical to that of qᵢ(n), λ₁² is the variance of wᵢ^{x} in the i-channel, and we expect λ₁²=ρᵢ². Working with (R10) and the prior distribution models above, the posterior distribution of vᵢ is conditionally normal:

$$\begin{matrix}p ( {v}_{i} \vert y , {q}_{i} , {r}_{{i}^{′}} ) = 2 \frac{φ ( {v}_{i} \vert \frac{{ρ}_{i}^{2}}{{q}_{i}} )}{p ( {v}_{i}^{y} \vert {q}_{i} , {r}_{{i}^{′}} )} \\ \{ φ ( {w}_{{i}^{′}} \vert 4 {σ}^{2} ) {⊗}_{{w}_{{i}^{′}}} φ ( {w}_{{i}^{′}} \vert \frac{{λ}_{{i}^{′}}^{2}}{{r}_{{i}^{′}}} ) \} ( 2 {v}_{i}^{y} - {v}_{i} ) \\ = 2 \frac{φ ( {v}_{i} \vert \frac{{ρ}_{i}^{2}}{{q}_{i}} )}{p ( {v}_{i}^{y} \vert {q}_{i} , {r}_{{i}^{′}} )} φ ( 2 {v}_{i}^{y} ( n ) - {v}_{i} ( n ) \vert 4 {σ}^{2} + \frac{{λ}_{{i}^{′}}^{2}}{{r}_{{i}^{′}}} ) \\ = \frac{2}{p ( {v}_{i}^{y} \vert {q}_{i} , {r}_{{i}^{′}} )} φ ( {v}_{i} - \frac{( \frac{2 {ρ}_{i}^{2}}{{q}_{i}} ) {v}_{i}^{y}}{\frac{{ρ}_{i}^{2}}{{q}_{i}} + 4 {σ}^{2} + \frac{{λ}_{{i}^{′}}^{2}}{{r}_{{i}^{′}}}} \vert \frac{\frac{{ρ}_{i}^{2}}{{q}_{i}} ( 4 {σ}^{2} + \frac{{λ}_{{i}^{′}}^{2}}{{r}_{{i}^{′}}} )}{\frac{{ρ}_{i}^{2}}{{q}_{i}} + 4 {σ}^{2} + \frac{{λ}_{{i}^{′}}^{2}}{{r}_{{i}^{′}}}} ) ,\end{matrix}$$

where the sums of conditionally normal variables in (R9) and Lemma 5 lead to

p(vᵢ^{y}|qᵢ,r_{i′})=φ(2vᵢ^{y}|4σ²+ρᵢ²/qᵢ+λ_{i′}²/r_{i′}).

Integrating p(vᵢ|y, qᵢ, r_{i′}) over qᵢ and r_{i′}, we find the posterior distribution of vᵢ:

$$\begin{matrix}p ( {v}_{i} \vert y ) = \int \int p ( {v}_{i} \vert y , {q}_{i} , {r}_{{i}^{′}} ) p ( {q}_{i} , {r}_{{i}^{′}} \vert y ) d {q}_{i} d {r}_{{i}^{′}} \\ = 2 \int \int φ ( {v}_{i} - \frac{( \frac{2 {ρ}_{i}^{2}}{{q}_{i}} ) {v}_{i}^{y}}{\frac{{ρ}_{i}^{2}}{{q}_{i}} + 4 {σ}^{2} + \frac{{λ}_{{i}^{′}}^{2}}{{r}_{{i}^{′}}}} \vert \frac{\frac{{ρ}_{i}^{2}}{{q}_{i}} ( 4 {σ}^{2} + \frac{{λ}_{{i}^{′}}^{2}}{{r}_{{i}^{′}}} )}{\frac{{ρ}_{i}^{2}}{{q}_{i}} + 4 {σ}^{2} + \frac{{λ}_{{i}^{′}}^{2}}{{r}_{{i}^{′}}}} ) \\ \frac{p ( {q}_{i} , {r}_{{i}^{′}} \vert y )}{p ( {v}_{i}^{y} \vert {q}_{i} , {r}_{{i}^{′}} )} d {q}_{i} d {r}_{{i}^{′}} \\ = \frac{2}{p ( {v}_{i}^{y} )} \int \int φ ( {v}_{i} - \frac{( \frac{2 {ρ}_{i}^{2}}{{q}_{i}} ) {v}_{i}^{y}}{\frac{{ρ}_{i}^{2}}{{q}_{i}} + 4 {σ}^{2} + \frac{{λ}_{{i}^{′}}^{2}}{{r}_{{i}^{′}}}} \vert \frac{\frac{{ρ}_{i}^{2}}{{q}_{i}} ( 4 {σ}^{2} + \frac{{λ}_{{i}^{′}}^{2}}{{r}_{{i}^{′}}} )}{\frac{{ρ}_{i}^{2}}{{q}_{i}} + 4 {σ}^{2} + \frac{{λ}_{{i}^{′}}^{2}}{{r}_{{i}^{′}}}} ) \\ p ( {q}_{i} ) p ( {r}_{{i}^{′}} ) d {q}_{i} d {r}_{{i}^{′}} ,\end{matrix} \qquad ( R 11 )$$

where the last step makes use of the joint posterior distribution of qᵢ and rᵢ:

$$\begin{matrix}\begin{matrix}p ( {q}_{i} , {r}_{{i}^{′}} \vert y ) = \frac{p ( y \vert {q}_{i} , {r}_{i} ) p ( {q}_{i} ) p ( {r}_{{i}^{′}} )}{p ( y )} \\ = \frac{p ( {v}_{i}^{y} \vert {q}_{i} , {r}_{i} ) p ( {q}_{i} ) p ( {r}_{{i}^{′}} )}{p ( {v}_{i}^{y} )}\end{matrix} & ( R 12 ) \\ \begin{matrix}p ( {v}_{i}^{y} ) = \int \int p ( {v}_{i}^{y} \vert {q}_{i} , {r}_{{i}^{′}} ) p ( {q}_{i} ) p ( {r}_{{i}^{′}} ) d {q}_{i} d {r}_{{i}^{′}} \\ = 2 \int \int φ ( 2 {v}_{i}^{y} \vert 4 {σ}^{2} + \frac{{ρ}_{i}^{2}}{{q}_{i}} + \frac{{λ}_{{i}^{′}}^{2}}{{r}_{{i}^{′}}} ) p ( {q}_{i} ) p ( {r}_{{i}^{′}} ) d {q}_{i} d {r}_{{i}^{′}} .\end{matrix} & ( R 13 )\end{matrix}$$

For some choices of p(qᵢ) and p(r_{i′}), the integral above can be evaluated explicitly (e.g. if vᵢ has Laplace distribution, or if qᵢ is a discrete variable). In one example, when the closed form expression for the integral does not exist, the integral may be evaluated numerically via approximation techniques such as Reimann sum, numerical quadrature, and Monte Carlo methods.

Bayes Estimator for Filterbank Coefficients

Using the prior and the posterior distributions above, some examples derive estimators for the latent variables that minimize some Bayes risk functions (which may also be thought of as simultaneous interpolation and denoising). For example, the minimum mean squared error (MMSE) estimator is the posterior mean of vᵢ derived from (R11) and (R12):

$$\begin{matrix}{\hat{v}}_{i} = E ( {v}_{i} \vert y ) \\ = E ( E ( {v}_{i} \vert y , {q}_{i} , {r}_{{i}^{′}} ) \vert y ) \\ = \int \int E ( {v}_{i} \vert y , {q}_{i} , {r}_{{i}^{′}} ) p ( {q}_{i} , {r}_{{i}^{′}} \vert y ) d {q}_{i} d {r}_{{i}^{′}} \\ = \frac{2}{p ( {v}_{i}^{y} )} \int \int \frac{( \frac{2 {ρ}_{i}^{2}}{{q}_{i}} ) {v}_{i}^{y}}{\frac{{ρ}_{i}^{2}}{{q}_{i}} + 4 {σ}^{2} + \frac{{λ}_{{i}^{′}}^{2}}{{r}_{{i}^{′}}}} \\ φ ( 2 {v}_{i}^{y} \vert 4 {σ}^{2} + \frac{{ρ}_{i}^{2}}{{q}_{i}} + \frac{{λ}_{{i}^{′}}^{2}}{{r}_{{i}^{′}}} ) p ( {q}_{i} ) p ( {r}_{{i}^{′}} ) d {q}_{i} d {r}_{{i}^{′}} .\end{matrix} \qquad ( R 14 )$$

Although MMSE estimators permeate the optimization literature, it is not as robust as the minimum l¹ error estimator when the underlying signal is inhomogeneous. The optimal estimate in the l¹ error sense, in one embodiment, is the posterior median of vᵢ, or a choice of \hat{v}ᵢ that solves

$$\begin{matrix}\begin{matrix}\frac{1}{2} = {\int }_{- ∞}^{{\hat{v}}_{i}} p ( {v}_{i} \vert y ) d {v}_{i} \\ = \frac{2}{p ( {v}_{i}^{y} )} {\int }_{- ∞}^{{\hat{v}}_{i}} \int \int φ ( {v}_{i} - \frac{( \frac{2 {ρ}_{i}^{2}}{{q}_{i}} ) {v}_{i}^{y}}{\frac{{ρ}_{i}^{2}}{{q}_{i}} + 4 {σ}^{2} + \frac{{λ}_{{i}^{′}}^{2}}{{r}_{{i}^{′}}}} \vert \frac{\frac{{ρ}_{i}^{2}}{{q}_{i}} ( 4 {σ}^{2} + \frac{{λ}_{{i}^{′}}^{2}}{{r}_{{i}^{′}}} )}{\frac{{ρ}_{i}^{2}}{{q}_{i}} + 4 {σ}^{2} + \frac{{λ}_{{i}^{′}}^{2}}{{r}_{{i}^{′}}}} ) \\ p ( {q}_{i} ) p ( {r}_{{i}^{′}} ) d {q}_{i} d {r}_{{i}^{′}} \\ = \frac{2}{p ( {v}_{i}^{y} )} \int \int Φ ( {\hat{v}}_{i} - \frac{( \frac{2 {ρ}_{i}^{2}}{{q}_{i}} ) {v}_{i}^{y}}{\frac{{ρ}_{i}^{2}}{{q}_{i}} + 4 {σ}^{2} + \frac{{λ}_{{i}^{′}}^{2}}{{r}_{{i}^{′}}}} \vert \frac{\frac{{ρ}_{i}^{2}}{{q}_{i}} ( 4 {σ}^{2} + \frac{{λ}_{{i}^{′}}^{2}}{{r}_{{i}^{′}}} )}{\frac{{ρ}_{i}^{2}}{{q}_{i}} + 4 {σ}^{2} + \frac{{λ}_{{i}^{′}}^{2}}{{r}_{{i}^{′}}}} ) \\ p ( {q}_{i} ) p ( {r}_{{i}^{′}} ) d {q}_{i} d {r}_{{i}^{′} ,}\end{matrix} & ( R 15 ) \\ where Φ ( x \vert {σ}^{2} ) = \frac{1}{2} ( 1 + erf ( \frac{x}{\sqrt{2 {σ}^{2}}} ) ) & \end{matrix}$$

is the cumulative distribution function of φ(x|σ²). Note that the l² and estimators in (R14) and (R15) can be pre-computed when the model parameters σ², ρᵢ², λᵢ² and the distributions of qᵢ and r_{i′} are known a priori.

Maximum Likelihood Estimation for Parameters

In some examples, the maximum likelihood estimate (MLE) of the model parameters may not have an analytic form when the integral in the marginal likelihood (R13) cannot be found explicitly. In one case, there exists an application of ECME (expectation-conditional maximization either) algorithm that estimate these parameters. The computational burden of the proposed ECME algorithm is far improved, owing to the conciseness of the likelihood function.

Specifically, for some embodiments assume that y (or equivalently, vᵢ^{y}(n)) is the only observed data and let θ₁={σ²,ρᵢ²}, where λᵢ²=σᵢ² is used and the identical distributions for qᵢ and rᵢ, and θ₂ are a set of all unknown parameters that the distribution for qᵢ needs. The object of ECME in this example is to estimate θ={θ₁,θ₂} by maximizing the marginal log-likelihood

$$\hat{θ} = arg {max}_{θ} log p ( y \vert θ ) . \qquad ( R 16 )$$

In some embodiments, the direct maximization may be difficult because of the complexities associated with the integral in (R13). The ECME algorithm circumvents this problem by iteratively maximizing the much easier augmented-data log-likelihood log p(U|θ), where U={y, x, q} is the augmented data and q={qᵢ(n)|∀i,n}. Given θ^{t}={θ₁^{t},η₂^{t}}, the tth iterate of the model parameters, the algorithm makes the use of the celebrated monotonicity property of log-likelihood functions:

log p(y|θ₁,θ₂^{t})−log p(y|θ₁^{t},θ₂^{t})≧Q({θ₁,θ₂^{t}};{θ₁^{t},θ₂^{t}})−Q({θ₁^{t},θ₂^{t}};{θ₁^{t},θ₂^{t}}),

where

Q(θ;θ^{t})=E[ log p(U|θ)|y,θ^{t}].

Thus, the choice of θ₁ that maximizes Q({θ₁,θ₂^{t}};θ^{t})—that is, the next iterate of θ₁—increases our objective function, log p(y|{θ₁^{t+1},θ₂^{t}})≧log p(y|θ^{t}). The advantage of one embodiment in maximizing Q( [symbol] ) instead of directly the targeted observed data log-likelihood function is that the augmented-data log-likelihood often depends on U linearly via a set of augmented-data sufficient statistics S(U).

The ECME algorithm is carried out by iterating these basic steps:
(E-step) Compute E[S(U)|y,θ^{t}]
(CM1-step) θ₁^{t+1}=arg_{maxθ}_{₁}Q({θ₁,θ₂^{t}}:θ^{t})
(CM2-step) θ₂^{t+1}=arg_{maxθ}_{₂} log p(y|{θ₁^{t+1},θ₂})

The iteration continues until log p(y|θ^{t}) converges. In the ECME context, computation of E[S(U)|y,θ^{t}] is referred to the E-step (expectation step), whereas the steps to compute maximization of Q( [symbol] ) and the log-likelihood function are called the CM-steps (conditional maximization steps). Below, discussed is an example of the CM-steps first, as the details of the sufficient statistics emerge from CM1-step.

Conditional Maximization Steps

Given the t th iterate parameter, the explicit formula for Q(θ;θ^{t}) is in a closed-form:

$$\begin{matrix}Q ( θ ; {θ}^{t} ) = E [ log p ( U \vert θ ) \vert y , {θ}^{t} ] \\ = E [ log p ( y \vert x , {θ}_{1} ) + log p ( x \vert q , {θ}_{1} ) + log p ( q \vert {θ}_{2} ) \vert y , {θ}^{t} ] \\ = E [ \begin{matrix}{\sum }_{i , n} log p ( {v}_{i}^{y} \vert {v}_{i} , {w}_{{i}^{′}} , {θ}_{1} ) + \\ log p ( {v}_{i} \vert {q}_{i} , {θ}_{1} ) + log p ( {q}_{i} \vert {θ}_{2} ) \vert y , {θ}^{t}\end{matrix} ]\end{matrix}$$

Taking the derivative with respect to θ₁, it is easy to verify that the maximizer of Q({θ₁,θ₂^{t}};θ^{t}) is the weighted least-squares estimate in some embodiments:

$$\begin{matrix}{\{ {σ}^{2} \}}^{t + 1} = ( 1 / N ) {\sum }_{i , n} E [ {( {v}_{i}^{y} - \frac{1}{2} [ {v}_{i} + {( - 1 )}^{{i}_{0}} {w}_{{i}^{′}} ] )}^{2} \vert y , {θ}^{t} ] \\ = ( 1 / N ) {\sum }_{i , n} E [ \begin{matrix}{\{ {v}_{i}^{y} \}}^{2} - {v}_{i}^{y} {v}_{i} - {( - 1 )}^{{i}_{0}} {v}_{i}^{y} {w}_{{i}^{′}} + \\ \frac{{\{ {v}_{i} \}}^{2}}{4} + {( - 1 )}^{{i}_{0}} \frac{{v}_{i} {w}_{{i}^{′}}}{2} + \frac{{\{ {w}_{{i}^{′}} \}}^{2}}{4} \vert y , {θ}^{t}\end{matrix} ] \\ = ( 1 / N ) {\sum }_{i , n} ( \begin{matrix}\begin{matrix}{\{ {v}_{i}^{y} \}}^{2} - E [ {v}_{i}^{y} {v}_{i} \vert y , {θ}^{t} ] - \\ {( - 1 )}^{{i}_{0}} E [ {v}_{i}^{y} {w}_{{i}^{′}} \vert y , {θ}^{t} ] +\end{matrix} \\ \begin{matrix}( 1 / 4 ) E [ {\{ {v}_{i} \}}^{2} \vert y , {θ}^{t} ] + \\ \begin{matrix}( {( - 1 )}^{{i}_{0}} / 2 ) E [ {v}_{i} {w}_{{i}^{′}} \vert y , {θ}^{t} ] + \\ ( 1 / 4 ) E [ {\{ {w}_{{i}^{′}} \}}^{2} \vert y , {θ}^{t} ]\end{matrix}\end{matrix}\end{matrix} )\end{matrix}$$

$${\{ {ρ}_{i}^{2} \}}^{t + 1} = ( 1 / {N}_{i} ) {\sum }_{n} E [ {q}_{i} {\{ {v}_{i} \}}^{2} \vert y , {θ}^{t} ]$$

where N is the total number of samples in the signal and N₁ is the number of coefficients in the ith subband. Thus the sufficient statistics are:

S(U)={vᵢ^{y}vᵢ,vᵢ^{y}w_{i′},{vᵢ}²,vᵢw_{o′},{w_{i′}}²,qᵢ{vᵢ}²}

According to one aspect, the maximization of log p(y|{θ₁^{t+1},θ₂}) with respect to θ₂ is a problem highly dependent on the choice of probability distribution considered for qᵢ. Assuming sufficient smoothness, the computation of the second CM-step solves the value of θ₂ that satisfy l′(θ₂|θ₁^{t+1})=0, where l′(θ₂|θ₁) is the first derivative of l(θ₂|θ₁)=log p(y|θ₁,θ₂) with respect to θ₂ (define l″(θ₂|θ₁) similarly as the second derivative). Then the procedure can be carried out via Newton-Raphson:

$${θ}_{2}^{new} = {θ}_{2}^{old} - \frac{{l}^{′} ( {θ}_{2}^{old} \vert {θ}_{1}^{t + 1} )}{{l}^{″} ( {θ}_{2}^{old} \vert {θ}_{1}^{t + 1} )} , \qquad ( R 17 )$$

where the iteration in (R17) is carried out until θ₂ converges.

Expectation Step

In the E-step, we evaluate

$$\begin{matrix}E [ S ( U ) \vert y , {θ}^{t} ] = E [ E [ S ( U ) \vert {q}_{i} , {r}_{{i}^{′}} , y , {θ}^{t} ] \vert y , {θ}^{t} ] \\ = \int \int E [ S ( U ) \vert {q}_{i} , {r}_{{i}^{′}} , y , {θ}^{t} ] p ( {q}_{i} , {r}_{{i}^{′}} \vert y , {θ}^{t} ] d {q}_{i} d {r}_{{i}^{′}} ,\end{matrix}$$

where p(qᵢ, r_{i′}|y, θ^{t}) is a computable quantity according to (R12). When the integration over qᵢ and r_{i′} does not have a closed-form, it is evaluated numerically as before. Using (R14) and conditioned on qᵢ and r_{i′}, all covariance matrices of interest can be calculated analytically:

$$\begin{matrix}E ⌊ {v}_{i}^{y} {v}_{i} \vert {q}_{i} , {r}_{{i}^{′}} , y , {θ}^{t} ⌋ = {v}_{i}^{y} E [ {v}_{i} \vert {q}_{i} , {r}_{{i}^{′}} , y , {θ}^{t} ] \\ = \frac{\frac{2 {ρ}_{i}^{2}}{{q}_{i}}}{\frac{{ρ}_{i}^{2}}{{q}_{i}} + 4 {σ}^{2} + \frac{{λ}_{{i}^{′}}^{2}}{{r}_{{i}^{′}}}} {\{ {v}_{i}^{y} \}}^{2}\end{matrix}$$

$$\begin{matrix}E [ {v}_{i}^{y} {w}_{{i}^{′}} \vert {q}_{i} , {r}_{{i}^{′}} , y , {θ}^{t} ] = {v}_{i}^{y} E [ {w}_{{i}^{′}} \vert {q}_{i} , {r}_{{i}^{′}} , y , {θ}^{t} ] \\ = \frac{\frac{2 {λ}_{{i}^{′}}^{2}}{{r}_{{i}^{′}}}}{\frac{{ρ}_{i}^{2}}{{q}_{i}} + 4 {σ}^{2} + \frac{{λ}_{{i}^{′}}^{2}}{{r}_{{i}^{′}}}} {\{ {v}_{i}^{y} \}}^{2}\end{matrix}$$

$$\begin{matrix}E [ {\{ {v}_{i} \}}^{2} \vert {q}_{i} , {r}_{{i}^{′}} , y , {θ}^{t} ] = Cov ( {v}_{i} \vert y , {θ}^{t} ) - {E [ {v}_{i} \vert {q}_{i} , {r}_{{i}^{′}} , y , {θ}^{t} ]}^{2} \\ = \frac{\frac{{ρ}_{i}^{2}}{{q}_{i}} ( 4 {σ}^{2} + \frac{{λ}_{{i}^{′}}^{2}}{{r}_{{i}^{′}}} )}{\frac{{ρ}_{i}^{2}}{{q}_{i}} + 4 {σ}^{2} + \frac{{λ}_{{i}^{′}}^{2}}{{r}_{{i}^{′}}}} - {( \frac{( \frac{2 {ρ}_{{i}^{′}}^{2}}{{q}_{i}} ) {v}_{i}^{y}}{\frac{{p}_{i}^{2}}{{q}_{i}} + 4 {σ}^{2} + \frac{{λ}_{{i}^{′}}^{2}}{{r}_{{i}^{′}}}} )}^{2}\end{matrix}$$

$$\begin{matrix}E [ {v}_{i} {w}_{{i}^{′}} \vert {q}_{i} , {r}_{{i}^{′}} , y , {θ}^{t} ] = E [ E [ {v}_{i} {w}_{{i}^{′}} \vert {v}_{i} , {q}_{i} , {r}_{{i}^{′}} , y , {θ}^{t} ] \vert {q}_{i} , {r}_{{i}^{′}} , y , {θ}^{t} ] \\ = E [ {v}_{i} ( \frac{\frac{2 {λ}_{{i}^{′}}^{2}}{{r}_{{i}^{′}}} ( {v}_{i}^{y} - {v}_{i} )}{4 {σ}^{2} + \frac{{λ}_{{i}^{′}}^{2}}{{r}_{{i}^{′}}}} ) \vert {q}_{i} , {r}_{{i}^{′}} , y , {θ}^{t} ] \\ = ( \frac{\frac{2 {λ}_{{i}^{′}}^{2}}{{r}_{{i}^{′}}}}{4 {σ}^{2} + \frac{{λ}_{{i}^{′}}^{2}}{{r}_{{i}^{′}}}} ) E [ {v}_{i}^{y} {v}_{i} - {\{ {v}_{i} \}}^{2} \vert {q}_{i} , {r}_{{i}^{′}} , y , {θ}^{t} ]\end{matrix}$$

$$E [ {\{ {w}_{{i}^{′}} \}}^{2} \vert {q}_{i} , {r}_{{i}^{′}} , y , {θ}^{t} ] = \frac{\frac{{λ}_{{i}^{′}}^{2}}{{r}_{{i}^{′}}} ( 4 {σ}^{2} + \frac{{ρ}_{i}^{2}}{{q}_{i}} )}{\frac{{ρ}_{i}^{2}}{{q}_{i}} + 4 {σ}^{2} + \frac{{λ}_{{i}^{′}}^{2}}{{r}_{{i}^{′}}}} - {( \frac{( \frac{2 {λ}_{{i}^{′}}^{2}}{{r}_{{i}^{′}}} ) {v}_{i}^{y}}{\frac{{ρ}_{i}^{2}}{{q}_{i}} + 4 {σ}^{2} + \frac{{λ}_{{i}^{′}}^{2}}{{r}_{{i}^{′}}}} )}^{2}$$

$$E [ {q}_{i} {\{ {v}_{i} \}}^{2} \vert {q}_{i} , {r}_{{i}^{′}} , y , {θ}^{t} ] = \frac{{ρ}_{i}^{2} ( 4 {σ}^{2} + \frac{{λ}_{{i}^{′}}^{2}}{{r}_{{i}^{′}}} )}{\frac{{ρ}_{i}^{2}}{{q}_{i}} + 4 {σ}^{2} + \frac{{λ}_{{i}^{′}}^{2}}{{r}_{{i}^{′}}}} - \frac{1}{{q}_{i}} {( \frac{( 2 {ρ}_{{i}^{′}}^{2} ) {v}_{i}^{y}}{\frac{{ρ}_{i}^{2}}{{q}_{i}} + 4 {σ}^{2} + \frac{{λ}_{{i}^{′}}^{2}}{{r}_{{i}^{′}}}} )}^{2}$$

It should be understood that the present invention is not limited to red, green, and blue color components. Rather the present invention may comprise a CFA comprising any color and any number of colors.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1-14. (canceled)

15. A method for processing an image, the method comprising acts of:
accessing image data captured through a color filter array;
transforming the image data using at least one filterbank;
reconstructing an image from the transformed image data.

16. The method of claim 15, wherein reconstructing an image from the transformed image data further comprises an act of approximating at least one filterbank subband coefficient.

17. The method of claim 15, wherein transforming the image data using at least one filterbank further comprises separating color components of the spatially sampled image data.

18. The method of claim 15, wherein transforming the image data using at least one filterbank further comprises separating spectral energy of individual color components.

19. The method of claim 18, wherein separating spectral energy of individual color components includes an act of using a wavelet transform.

20. The method of claim 18, wherein separating the spectral energy of individual color components further comprises an act of using a two-level wavelet transform.

21. The method of claim 18, wherein separating the spectral energy of individual color components further comprises an act of using a multi-level wavelet transform.

22. The method of claim 15, wherein transforming the image data using at least one filterbank further comprises decomposing the image data into a plurality of filterbank subband coefficients.

23. The method of claim 22, wherein the plurality of filterbank subband coefficients comprise a complete filterbank.

24. The method of claim 22, wherein the plurality of filterbank subband coefficients comprise an overcomplete filterbank.

25. The method of claim 22, wherein the plurality of filterbank subband coefficients comprise at least one of complete filterbank, an overcomplete filterbank, an undecimated wavelet coefficient, and a decimated wavelet coefficient.

26. The method of claim 22, wherein at least one of the plurality of filterbank subband coefficients comprises at least one wavelet coefficient.

27. The method of claim 26, wherein the at least one wavelet coefficient describes a Daubechies wavelet.

28. The method of claim 26, wherein the at least one wavelet coefficient describes a Harr wavelet.

29. The method of claim 15, further comprising an act of denoising the image data prior to demosaicing the image data.

30. The method of claim 15, wherein the act of transforming the image data using at least one filterbank further comprises an act of performing denoising on the image data.

31. The method of claim 29, wherein the act of performing denoising on the image is wavelet based.

32. The method of claim 29, further comprising an act of estimating a luminance component of an image.

33. The method of claim 15, wherein the image data comprises a plurality of images.

34. The method of claim 33, wherein the plurality of images comprise video.

35. A method for reducing computational complexity associated with recovering an image, the method comprising:
accessing image data captured through a color filter array;
transforming the image data into a plurality of subband coefficients using a filterbank;
estimating at least one subband coefficient for a complete image based, at least in part, on the plurality of subband coefficients;
reconstructing, at least part of a complete image, using the estimated at least one subband coefficient for the complete image.

36. The method of claim 35, further comprising an act of denoising the image data.

37. The method of claim 36, wherein the act of denoising the image data occurs prior to demosaicing the image data.

38. The method of claim 35, wherein the act of transforming the image data using at least one filterbank further comprises an act of performing denoising on the image data.

39. The method of claim 36, wherein the act of performing denoising on the image is wavelet based.

40. The method of claim 37, further comprising an act of estimating a luminance component of an image.

41-70. (canceled)
